(19) United States
(12) Patent Application Publication
(10) Pub. No.: US 2023/0391337 A1
(43) Pub. Date: Dec. 7, 2023

(54) Advanced Driving Assistance System Using Fuzzy Logic

(71) Applicant: The University of Toledo, Toledo, OH (US)

(72) Inventors: Devinder Kaur, Toledo, OH (US); Tejaswi Kakarala, Toledo, OH (US)

(73) Assignee: The University of Toledo, Toledo, OH (US)

(21) Appl. No.: 18/205,012

(22) Filed: Jun. 2, 2023

Related U.S. Application Data
(60) Provisional application No. 63/348,611, filed on Jun. 3, 2022.

(51) Int. Cl. B60W 30/18; B60W 60/00

(52) U.S. Cl. CPC B60W 30/18163; B60W 60/001; B60W 2554/80; B60W 2552/00

(57) ABSTRACT

Advanced drying systems including a vehicle having a fuzzy inference system with a speed control logic set containing fuzzy logic rules, a lane change logic set containing fuzzy logic rules, or both, and related methods and systems are described.

### RELATED APPLICATIONS

This application claims priority to U.S. Provisional Application No. 63/348,611 filed under 35 U.S.C. § 111(b) on Jun. 3, 2022, the disclosure of which is incorporated herein by reference in its entirety for all purposes.

### STATEMENT REGARDING FEDERALLY SPONSORED RESEARCH

This invention was made with no government support. The government has no rights in this invention.

### BACKGROUND

Autonomous vehicles are being used on the road to give the driver the means to accomplish other tasks rather than focusing on the road. These vehicles use an advanced driving assistance system to steer from one lane to another. The Society of Automotive Engineers has classified self-driving vehicles into stages, which range from level 0 to 5.

Level 0 to 3 self-driving vehicles are classified as vehicles in which a human being monitors the driving environment. A level 0 vehicle is a vehicle which has no automation. A vehicle at this level is completely controlled by a human being. This type of vehicle is the most common type of vehicle today. A level 1 vehicle is a vehicle which provides driver assistance. A vehicle at this level features a single automated system. A level 2 vehicle is one which includes partial automation. A vehicle that can perform steering and/or acceleration is considered a level 2 vehicle. At this level, a human being monitors all of the tasks and can still overtake the automated system at any time.

Level 3 to 6 self-driving vehicles are classified as vehicles in which the automated system monitors the driving environment. A level 3 vehicle is a vehicle which has highly automated driving assistance. This level of vehicle has environmental detection capabilities, and the vehicle can perform most driving tasks. However, human override is still required. A level 4 vehicle is a vehicle which is fully autonomous with a steering wheel for the driver to take charge whenever he or she likes, but it can function without the driver's help. This level of vehicle requires geofencing. A level 5 vehicle is a vehicle which is fully automated and will take an individual from point A to point B without the help of the driver.

There is a need in the art for new and improved systems for facilitating autonomous driving, especially for vehicles that are level 2 or higher self-driving vehicles.

### SUMMARY

Provided is an advanced driving assistance system, the system comprising a vehicle having a fuzzy inference system and a sensor, wherein the sensor is configured to obtain a first input comprising a distance and a second input comprising a relative distance; the fuzzy inference system comprises a speed control logic set of fuzzy logic rules, the fuzzy inference system being configured to receive the first input and the second input from the sensor and generate an output relating to speed control; the vehicle is configured to receive the output generated from the fuzzy inference system; the distance is a measurement between the vehicle and an object in front of the vehicle; the relative distance is a measurement of a rate of change of a distance between the vehicle and the object; and the output is a value of acceleration or a value of breaking.

In certain embodiments, the fuzzy inference system is a Mamdani fuzzy inference system. In certain embodiments, the fuzzy inference system is a Sugeno fuzzy inference system.

In certain embodiments, each of the first input, the second input, and the output comprises five membership functions that are triangular in nature. In particular embodiments, the five membership functions of the first input comprise variables of very small, small, perfect, large, and very large; the five membership functions of the second input comprise variables of shrinking fast, shrinking, stable, growing, and growing fast; and the five membership functions of the output comprise variables of break hard, slow down, no action, speed up, and floor it. In particular embodiments, the speed control logic set includes 25 fuzzy logic rules, wherein a first rule makes a determination based on the distance being very small and the relative distance shrinking fast that the vehicle should slow down quickly; a second rule makes a determination based on the distance being very small and the relative distance being stable that the vehicle should slow down; a third rule makes a determination based on the distance being very small and the relative distance being stable that the vehicle should slow down; a fourth rule makes a determination based on the distance being very small and the relative distance growing that the vehicle should make no change to speed; a fifth rule makes a determination based on the distance being very small and the relative distance growing fast that the vehicle should accelerate; a sixth rule makes a determination based on the distance being small and the relative distance growing fast that the vehicle should slow down; a seventh rule makes a determination based on the distance being small and the relative distance shrinking that the vehicle should slow down; an eighth rule makes a determination based on the distance being small and the relative distance being stable that the vehicle should slow down; a ninth rule makes a determination based on the distance being small and the relative distance growing that the vehicle should make no change in speed; a tenth rule makes a determination based on the distance being small and the relative distance growing fast that the vehicle should accelerate; an eleventh rule makes a determination based on the distance being perfect and the relative distance shrinking fast that the vehicle should slow down; a twelfth rule makes a determination based on the distance being perfect and the relative distance shrinking that the vehicle should slow down; a thirteenth rule makes a determination based on the distance being perfect and relative distance being stable that the vehicle should make no change in speed; a fourteenth rule makes a determination based on the distance being perfect and the relative distance growing that the vehicle should accelerate; a fifteenth rule makes a determination based on the distance being perfect and the relative distance growing fast that the vehicle should accelerate; a sixteenth rule makes a determination based on the distance being large and the relative distance shrinking fast that the vehicle should slow down; a seventeenth rule makes a determination based on the distance being large and the relative distance shrinking that the vehicle should make no change in speed; an eighteenth rule makes a determination based on the distance being large and the relative distance being stable that the vehicle should accelerate; a nineteenth rule makes a determination based on the distance being large and the relative distance growing that the vehicle should accelerate; a twentieth rule makes a determination based on the distance being large and the relative distance growing fast that the vehicle should accelerate quickly; a twenty-first rule makes a determination based on the distance being very large and the relative distance shrinking fast that the vehicle should slow down; a twenty-second rule makes a determination based on the distance being very large and the relative distance shrinking that the vehicle should make no change in speed; a twenty-third rule makes a determination based on the distance being very large and the relative distance being stable that the vehicle should accelerate; a twenty-fourth rule makes a determination based on the distance being very large and the relative distance growing that the vehicle should accelerate quickly; and a twenty-fifth rule makes a determination based on the distance being very large and the relative distance growing fast that the vehicle should accelerate quickly.

Further provided is a method of controlling speed in a vehicle using an advanced driving assistance system, the method comprising obtaining a first input with a sensor, the first input comprising a distance between the vehicle and an object in front of the vehicle; obtaining a second input with the sensor, the second input comprising a relative distance, wherein the relative distance is a measurement of a rate of change of the distance; and implementing a fuzzy inference system by applying a set of fuzzy logic rules to the obtained first input and second input so as to generate an output comprising a recommendation to adjust or maintain a speed of the vehicle.

In certain embodiments, the fuzzy inference system is a Mamdani fuzzy inference system. In certain embodiments, the fuzzy inference system is a Sugeno fuzzy inference system.

In certain embodiments, each of the first input, the second input, and the output comprises five membership functions that are triangular in nature. In particular embodiments, the five membership functions of the first input comprise variables of very small, small, perfect, large, and very large; the five membership functions of the second input comprise variables of shrinking fast, shrinking, stable, growing, and growing fast; and the five membership functions of the output comprise variables of break hard, slow down, no action, speed up, and floor it. In particular embodiments, the speed control logic set includes 25 fuzzy logic rules, wherein a first rule makes a determination based on the distance being very small and the relative distance shrinking fast that the vehicle should slow down quickly; a second rule makes a determination based on the distance being very small and the relative distance being stable that the vehicle should slow down; a third rule makes a determination based on the distance being very small and the relative distance being stable that the vehicle should slow down; a fourth rule makes a determination based on the distance being very small and the relative distance growing that the vehicle should make no change to speed; a fifth rule makes a determination based on the distance being very small and the relative distance growing fast that the vehicle should accelerate; a sixth rule makes a determination based on the distance being small and the relative distance growing fast that the vehicle should slow down; a seventh rule makes a determination based on the distance being small and the relative distance shrinking that the vehicle should slow down; an eighth rule makes a determination based on the distance being small and the relative distance being stable that the vehicle should slow down; a ninth rule makes a determination based on the distance being small and the relative distance growing that the vehicle should make no change in speed; a tenth rule makes a determination based on the distance being small and the relative distance growing fast that the vehicle should accelerate; an eleventh rule makes a determination based on the distance being perfect and the relative distance shrinking fast that the vehicle should slow down; a twelfth rule makes a determination based on the distance being perfect and the relative distance shrinking that the vehicle should slow down; a thirteenth rule makes a determination based on the distance being perfect and relative distance being stable that the vehicle should make no change in speed; a fourteenth rule makes a determination based on the distance being perfect and the relative distance growing that the vehicle should accelerate; a fifteenth rule makes a determination based on the distance being perfect and the relative distance growing fast that the vehicle should accelerate; a sixteenth rule makes a determination based on the distance being large and the relative distance shrinking fast that the vehicle should slow down; a seventeenth rule makes a determination based on the distance being large and the relative distance shrinking that the vehicle should make no change in speed; an eighteenth rule makes a determination based on the distance being large and the relative distance being stable that the vehicle should accelerate; a nineteenth rule makes a determination based on the distance being large and the relative distance growing that the vehicle should accelerate; a twentieth rule makes a determination based on the distance being large and the relative distance growing fast that the vehicle should accelerate quickly; a twenty-first rule makes a determination based on the distance being very large and the relative distance shrinking fast that the vehicle should slow down; a twenty-second rule makes a determination based on the distance being very large and the relative distance shrinking that the vehicle should make no change in speed; a twenty-third rule makes a determination based on the distance being very large and the relative distance being stable that the vehicle should accelerate; a twenty-fourth rule makes a determination based on the distance being very large and the relative distance growing that the vehicle should accelerate quickly; and a twenty-fifth rule makes a determination based on the distance being very large and the relative distance growing fast that the vehicle should accelerate quickly.

Further provided is an advanced driving assistance system comprising a vehicle having a fuzzy inference system and a sensor, the sensor being configured to obtain a first input comprising a lane detection, a second input comprising a distance, and a third input comprising a relative distance, wherein the fuzzy inference system is a lane change logic set of fuzzy logic rules, the fuzzy inference system being configured to receive the first input, the second input, and the third input from the sensor and generate an output comprising a lane change recommendation based on the first input, the second input, and the third input; the lane detection is the detection of a parallel lane into which the vehicle may move through a change of lanes; the distance is a measurement between the vehicle and an object in front of the vehicle; and the relative distance is a measurement of the rate of change of a distance between the vehicle and an object detected in the parallel lane.

In certain embodiments, the fuzzy inference system is a Mamdani fuzzy inference system. In certain embodiments, the fuzzy inference system is a Sugeno fuzzy inference system.

In certain embodiments, each of the first input, the second input, and the third input comprises three membership functions that are triangular or trapezoidal in nature, and wherein the output comprises four membership functions. In particular embodiments, the three membership functions of the first input comprise variables of right lane, middle lane, and left lane; the three membership functions of the second input comprise variables of small, perfect, and large; the three membership functions of the third input comprise variables of shrinking, stable, and growing; and the four membership functions of the output comprise variables of right lane, middle lane, left lane, and no action. In particular embodiments, wherein the lane change logic set of fuzzy logic rules includes 27 fuzzy logic rules, wherein a first rule makes a determination based on the lane detection being right lane, the distance being small, and the relative distance shrinking that the vehicle should stay in its current lane; a second rule makes a determination based on the lane detection being right lane, the distance being small, and the relative distance being stable that the vehicle should stay in its current lane; a third rule makes a determination based on the lane detection being right lane, the distance being small, and the relative distance growing that the vehicle should stay in its current lane; a fourth rule makes a determination based on the lane detection being right lane, the distance being perfect, and the relative distance shrinking that the vehicle should stay in its current lane; a fifth rule makes a determination based on the lane detection being right lane, the distance being perfect, and the relative distance being stable that the vehicle should change to the right lane; a sixth rule makes a determination based on the lane detection being right lane, the distance being perfect, and the relative distance growing that the vehicle should change to the right lane; a seventh rule makes a determination based on the lane detection being right lane, the distance being large, and the relative distance shrinking that the vehicle should change to the right lane; an eighth rule makes a determination based on the lane detection being right lane, the distance being large, and the relative distance being stable that the vehicle should change to the right lane; a ninth rule makes a determination based on the lane detection being right lane, the distance being large, and the relative distance growing that the vehicle should change to the right lane; a tenth rule makes a determination based on the lane detection being middle lane, the distance being small, and the relative distance shrinking that the vehicle should stay in its current lane; an eleventh rule makes a determination based on the lane detection being middle lane, the distance being small, and the relative distance being stable that the vehicle should stay in its current lane; a twelfth rule makes a determination based on the lane detection being middle lane, the distance being small, and the relative distance growing that the vehicle should change to the middle lane; a thirteenth rule makes a determination based on the lane detection being middle lane, the distance being perfect, and the relative distance shrinking that the vehicle should stay in its current lane; a fourteenth rule makes a determination based on the lane detection being middle lane, the distance being perfect, and the relative distance being stable that the vehicle should change to the middle lane; a fifteenth rule makes a determination based on the lane detection being middle lane, the distance being perfect, and the relative distance growing that the vehicle should change to the middle lane; a sixteenth rule makes a determination based on the lane detection being middle lane, the distance being large, and the relative distance shrinking that the vehicle should change to the middle lane; a seventeenth rule makes a determination based on the lane detection being middle lane, the distance being large, and the relative distance being stable that the vehicle should change to the middle lane; an eighteenth rule makes a determination based on the lane detection being middle lane, the distance being large, and the relative distance growing that the vehicle should change to the middle lane; a nineteenth rule makes a determination based on the lane detection being left lane, the distance being small, and the relative distance shrinking that the vehicle should stay in its current lane; a twentieth rule makes a determination based on the lane detection being left land, the distance being small, and the relative distance being stable that the vehicle should stay in its current lane; a twenty-first rule makes a determination based on the lane detection being left lane, the distance being small, and the relative distance growing that the vehicle should change to the left lane; a twenty-second rule makes a determination based on the lane detection being left lane, the distance being perfect, and the relative distance shrinking that the vehicle should stay in its current lane; a twenty-third rule makes a determination based on the lane detection being left lane, the distance being perfect, and the relative distance being stable that the vehicle should change to the left lane; a twenty-fourth rule makes a determination based on the lane detection being left lane, the distance being perfect, and the relative distance growing that the vehicle should change to the left lane; a twenty-fifth rule makes a determination based on the lane detection being left lane, the distance being large, and the relative distance shrinking that the vehicle should change to the left lane; a twenty-sixth rule makes a determination based on the lane detection being left lane, the distance being large, and the relative distance being stable that the vehicle should change to the left lane; and a twenty-seventh rule makes a determination based on the lane detection being left lane, the distance being large, and the relative distance growing that the vehicle should change to the left lane.

Further provided is a method of changing lanes in a vehicle using an advanced driving assistance system, the method comprising obtaining a first input with a sensor, the first input comprising a lane detection, wherein the lane detection is a detection of a parallel lane into which the vehicle may move in a change of lanes; obtaining a second input with the sensor, the second input comprising a distance, wherein the distance is a measurement between the vehicle and an object in front of the vehicle; obtaining a third input with the sensor, the third input comprising a relative distance, wherein the relative distance is a measurement of a rate of change of a distance between the vehicle and an object detected in the parallel lane; and implementing a fuzzy inference system to apply a set of fuzzy logic rules to the first input, the second input, and the third input so as to generate an output, wherein the output comprises a recommendation on whether the vehicle should change lanes into the parallel lane.

In certain embodiments, the fuzzy inference system is a Mamdani fuzzy inference system. In certain embodiments, the fuzzy inference system is a Sugeno fuzzy inference system.

In certain embodiments, each of the first input, the second input, and the fourth input comprises three membership functions that are triangular or trapezoidal in nature, and the output comprises four membership functions. In particular embodiments, the three membership functions of the first input comprise variables of right lane, middle lane, and left lane; the three membership functions of the second input comprise variables of small, perfect, and large; the three membership functions of the third input comprise variables of shrinking, stable, and growing; and the four membership functions of the output comprise variables of right lane, middle lane, left lane, and no action. In particular embodiments, the set of fuzzy logic rules includes 27 fuzzy logic rules, wherein a first rule makes a determination based on the lane detection being right lane, the distance being small, and the relative distance shrinking that the vehicle should stay in its current lane; a second rule makes a determination based on the lane detection being right lane, the distance being small, and the relative distance being stable that the vehicle should stay in its current lane; a third rule makes a determination based on the lane detection being right lane, the distance being small, and the relative distance growing that the vehicle should stay in its current lane; a fourth rule makes a determination based on the lane detection being right lane, the distance being perfect, and the relative distance shrinking that the vehicle should stay in its current lane; a fifth rule makes a determination based on the lane detection being right lane, the distance being perfect, and the relative distance being stable that the vehicle should change to the right lane; a sixth rule makes a determination based on the lane detection being right lane, the distance being perfect, and the relative distance growing that the vehicle should change to the right lane; a seventh rule makes a determination based on the lane detection being right lane, the distance being large, and the relative distance shrinking that the vehicle should change to the right lane; an eighth rule makes a determination based on the lane detection being a right lane, the distance being large, and the relative distance being stable that the vehicle should change to the right lane; a ninth rule makes a determination based on the lane detection being right lane, the distance being large, and the relative distance growing that the vehicle should change to the right lane; a tenth rule makes a determination based on the lane detection being middle lane, the distance being small, and the relative distance shrinking that the vehicle should stay in its current lane; an eleventh rule makes a determination based on the lane detection being middle lane, the distance being small, and the relative distance being stable that the vehicle should stay in its current lane; a twelfth rule makes a determination based on the lane detection being middle lane, the distance being small, and the relative distance growing that the vehicle should change to the middle lane; a thirteenth rule makes a determination based on the lane detection being middle lane, the distance being perfect, and the relative distance shrinking that the vehicle should stay in its current lane; a fourteenth rule makes a determination based on the lane detection being middle lane, the distance being perfect, and the relative distance being stable that the vehicle should change to the middle lane; a fifteenth rule makes a determination based on the lane detection being middle lane, the distance being perfect, and the relative distance growing that the vehicle should change to the middle lane; a sixteenth rule makes a determination based on the lane detection being middle lane, the distance being large, and the relative distance shrinking that the vehicle should change to the middle lane; a seventeenth rule makes a determination based on the lane detection being middle lane, the distance being large, and the relative distance being stable that the vehicle should change to the middle lane; an eighteenth rule makes a determination based on the lane detection being middle lane, the distance being large, and the relative distance growing that the vehicle should change to the middle lane; a nineteenth rule makes a determination based on the lane detection being left lane, the distance being small, and the relative distance shrinking that the vehicle should stay in its current lane; a twentieth rule makes a determination based on the lane detection being left land, the distance being small, and the relative distance being stable that the vehicle should stay in its current lane; a twenty-first rule makes a determination based on the lane detection being left lane, the distance being small, and the relative distance growing that the vehicle should change to the left lane; a twenty-second rule makes a determination based on the lane detection being left lane, the distance being perfect, and the relative distance shrinking that the vehicle should stay in its current lane; a twenty-third rule makes a determination based on the lane detection being left lane, the distance being perfect, and the relative distance being stable that the vehicle should change to the left lane; a twenty-fourth rule makes a determination based on the lane detection being left lane, the distance being perfect, and the relative distance growing that the vehicle should change to the left lane; a twenty-fifth rule makes a determination based on the lane detection being left lane, the distance being large, and the relative distance shrinking that the vehicle should change to the left lane; a twenty-sixth rule makes a determination based on the lane detection being left lane, the distance being large, and the relative distance being stable that the vehicle should change to the left lane; and a twenty-seventh rule makes a determination based on the lane detection being left lane, the distance being large, and the relative distance growing that the vehicle should change to the left lane.

Further provided is an advanced driving assistance system comprising a vehicle having a sensor in communication with a first fuzzy inference system and a second fuzzy inference system, wherein the sensor is configured to obtain a first input of the first fuzzy inference system comprising a first distance, a second input of the first fuzzy inference system comprising a first relative distance, a first input of the second fuzzy inference system comprising a lane detection, a second input of the second fuzzy inference system comprising the distance, and a third input of the second fuzzy inference system comprising a second relative distance; wherein the first fuzzy inference system comprises a speed control logic set of fuzzy logic rules, and is configured to receive the first input of the first fuzzy inference system and the second input of the first fuzzy inference system from the sensor, and generate a first output comprising a speed control recommendation; the second fuzzy inference system comprises a lane change logic set of fuzzy logic rules, and is configured to receive the first input of the second fuzzy inference system, the second input of the second fuzzy inference system, and the third input of the second fuzzy inference system, and generate a second output comprising a lane change recommendation; the distance is a measurement between the vehicle and an object in front of the vehicle; the relative distance is a measurement of a rate of change of the distance; the lane detection is a detection of a parallel lane into which the vehicle may move in a change of lanes; and the second relative distance is a measurement of the rate of change of a second distance between the vehicle and an object detected in the parallel lane.

In certain embodiments, one or both of the first fuzzy inference system and the second fuzzy inference system is a Mamdani fuzzy inference system. In certain embodiments, one or both of the first fuzzy inference system and the second fuzzy inference system is a Sugeno fuzzy inference system.

In certain embodiments, each of the first input, the second input, and the output of the first fuzzy inference system comprises five membership functions that are triangular in nature, wherein each of the first input and the second input of the second fuzzy inference system comprises three membership functions that are triangular or trapezoidal in nature, and the output of the second fuzzy inference system comprises four membership functions. In particular embodiments, the five membership functions of the first input of the first fuzzy inference system comprise variables of very small, small, perfect, large, and very large; the five membership functions of the second input of the first fuzzy inference system comprise variables of shrinking fast, shrinking, stable, growing, and growing fast; the five membership functions of the output of the first fuzzy inference system comprise variables of break hard, slow down, no action, speed up, and floor it; the three membership functions of the first input of the second fuzzy inference system comprise variables of right lane, middle lane, and left lane; the three membership functions of the second input of the second fuzzy inference system comprise variables of small, perfect, and large; the three membership functions of the third input of the second fuzzy inference system comprise variables of shrinking, stable, and growing; and the four membership functions of the output of the second fuzzy inference system comprise variables of right lane, middle lane, left lane, and no action. In particular embodiments, the speed control logic set of fuzzy logic rules includes 25 rules, and the lane change logic set of fuzzy logic rules includes 27 rules, wherein a first rule of the speed control logic set makes a determination based on the distance being very small and the relative distance shrinking fast that the vehicle should slow down quickly; a second rule of the speed control logic set makes a determination based on the distance being very small and the relative distance being stable that the vehicle should slow down; a third rule of the speed control logic set makes a determination based on the distance being very small and the relative distance being stable that the vehicle should slow down; a fourth rule of the speed control logic set makes a determination based on the distance being very small and the relative distance growing that the vehicle should make no change to speed; a fifth rule of the speed control logic set makes a determination based on the distance being very small and the relative distance growing fast that the vehicle should accelerate; a sixth rule of the speed control logic set makes a determination based on the distance being small and the relative distance growing fast that the vehicle should slow down; a seventh rule of the speed control logic set makes a determination based on the distance being small and the relative distance shrinking that the vehicle should slow down; an eighth rule of the speed control logic set makes a determination based on the distance being small and the relative distance being stable that the vehicle should slow down; a ninth rule of the speed control logic set makes a determination based on the distance being small and the relative distance growing that the vehicle should make no change in speed; a tenth rule of the speed control logic set makes a determination based on the distance being small and the relative distance growing fast that the vehicle should accelerate; an eleventh rule makes a determination based on the distance being perfect and the relative distance shrinking fast that the vehicle should slow down; a twelfth rule of the speed control logic set makes a determination based on the distance being perfect and the relative distance shrinking that the vehicle should slow down; a thirteenth rule of the speed control logic set makes a determination based on the distance being perfect and relative distance being stable that the vehicle should make no change in speed; a fourteenth rule of the speed control logic set makes a determination based on the distance being perfect and the relative distance growing that the vehicle should accelerate; a fifteenth rule of the speed control logic set makes a determination based on the distance being perfect and the relative distance growing fast that the vehicle should accelerate; a sixteenth rule of the speed control logic set makes a determination based on the distance being large and the relative distance shrinking fast that the vehicle should slow down; a seventeenth rule of the speed control logic set makes a determination based on the distance being large and the relative distance shrinking that the vehicle should make no change in speed; an eighteenth rule of the speed control logic set makes a determination based on the distance being large and the relative distance being stable that the vehicle should accelerate; a nineteenth rule of the speed control logic set makes a determination based on the distance being large and the relative distance growing that the vehicle should accelerate; a twentieth rule of the speed control logic set makes a determination based on the distance being large and the relative distance growing fast that the vehicle should accelerate quickly; a twenty-first rule of the speed control logic set makes a determination based on the distance being very large and the relative distance shrinking fast that the vehicle should slow down; a twenty-second rule of the speed control logic set makes a determination based on the distance being very large and the relative distance shrinking that the vehicle should make no change in speed; a twenty-third rule of the speed control logic set makes a determination based on the distance being very large and the relative distance being stable that the vehicle should accelerate; a twenty-fourth rule of the speed control logic set makes a determination based on the distance being very large and the relative distance growing that the vehicle should accelerate quickly; a twenty-fifth rule of the speed control logic set makes a determination based on the distance being very large and the relative distance growing fast that the vehicle should accelerate quickly; a first rule of the lane change logic set makes a determination based on the lane detection being right lane, the distance being small, and the relative distance shrinking that the vehicle should stay in its current lane; a second rule of the lane change logic set makes a determination based on the lane detection being right lane, the distance being small, and the relative distance being stable that the vehicle should stay in its current lane; a third rule of the lane change logic set makes a determination based on the lane detection being right lane, the distance being small, and the relative distance growing that the vehicle should stay in its current lane; a fourth rule of the lane change logic set makes a determination based on the lane detection being right lane, the distance being perfect, and the relative distance shrinking that the vehicle should stay in its current lane; a fifth rule makes a determination based on the lane detection being right lane, the distance being perfect, and the relative distance being stable that the vehicle should change to the right lane; a sixth rule of the lane change logic set makes a determination based on the lane detection being right lane, the distance being perfect, and the relative distance growing that the vehicle should change to the right lane; a seventh rule of the lane change logic set makes a determination based on the lane detection being right lane, the distance being large, and the relative distance shrinking that the vehicle should change to the right lane; an eighth rule of the lane change logic set makes a determination based on the lane detection being a right lane, the distance being large, and the relative distance being stable that the vehicle should change to the right lane; a ninth rule of the lane change logic set makes a determination based on the lane detection being right lane, the distance being large, and the relative distance growing that the vehicle should change to the right lane; a tenth rule of the lane change logic set makes a determination based on the lane detection being middle lane, the distance being small, and the relative distance shrinking that the vehicle should stay in its current lane; an eleventh rule of the lane change logic set makes a determination based on the lane detection being middle lane, the distance being small, and the relative distance being stable that the vehicle should stay in its current lane; a twelfth rule of the lane change logic set makes a determination based on the lane detection being middle lane, the distance being small, and the relative distance growing that the vehicle should change to the middle lane; a thirteenth rule of the lane change logic set makes a determination based on the lane detection being middle lane, the distance being perfect, and the relative distance shrinking that the vehicle should stay in its current lane; a fourteenth rule makes a determination based on the lane detection being middle lane, the distance being perfect, and the relative distance being stable that the vehicle should change to the middle lane; a fifteenth rule of the lane change logic set makes a determination based on the lane detection being middle lane, the distance being perfect, and the relative distance growing that the vehicle should change to the middle lane; a sixteenth rule of the lane change logic set makes a determination based on the lane detection being middle lane, the distance being large, and the relative distance shrinking that the vehicle should change to the middle lane; a seventeenth rule of the lane change logic set makes a determination based on the lane detection being middle lane, the distance being large, and the relative distance being stable that the vehicle should change to the middle lane; an eighteenth rule of the lane change logic set makes a determination based on the lane detection being middle lane, the distance being large, and the relative distance growing that the vehicle should change to the middle lane; a nineteenth rule of the lane change logic set makes a determination based on the lane detection being left lane, the distance being small, and the relative distance shrinking that the vehicle should stay in its current lane; a twentieth rule of the lane change logic set makes a determination based on the lane detection being left land, the distance being small, and the relative distance being stable that the vehicle should stay in its current lane; a twenty-first rule of the lane change logic set makes a determination based on the lane detection being left lane, the distance being small, and the relative distance growing that the vehicle should change to the left lane; a twenty-second rule of the lane change logic set makes a determination based on the lane detection being left lane, the distance being perfect, and the relative distance shrinking that the vehicle should stay in its current lane; a twenty-third rule of the lane change logic set makes a determination based on the lane detection being left lane, the distance being perfect, and the relative distance being stable that the vehicle should change to the left lane; a twenty-fourth rule of the lane change logic set makes a determination based on the lane detection being left lane, the distance being perfect, and the relative distance growing that the vehicle should change to the left lane; a twenty-fifth rule of the lane change logic set makes a determination based on the lane detection being left lane, the distance being large, and the relative distance shrinking that the vehicle should change to the left lane; a twenty-sixth rule of the lane change logic set makes a determination based on the lane detection being left lane, the distance being large, and the relative distance being stable that the vehicle should change to the left lane; and a twenty-seventh rule of the lane change logic set makes a determination based on the lane detection being left lane, the distance being large, and the relative distance growing that the vehicle should change to the left lane.

Further provided is a method of controlling speed and changing lanes in a vehicle using an advanced driving assistance system, the method comprising obtaining a first input of a first fuzzy inference system with a sensor, the first input of the first fuzzy inference system comprising a distance being between a vehicle and an object in front of the vehicle; obtaining a second input of the first fuzzy inference system with the sensor, the second input of the first fuzzy inference system comprising a relative distance, wherein the relative distance is a measurement of a rate of change being the distance; obtaining a first input of a second fuzzy inference system with the sensor, the first input for the second fuzzy inference system comprising a lane detection, the lane detection being a detection of a parallel lane into which the vehicle may move through a change of lanes; obtaining a second input of the second fuzzy inference system with the sensor, the second input for the second fuzzy inference system being the distance; obtaining a third input of the second fuzzy inference system with the sensor, the third input of the second fuzzy inference system comprising a relative distance, the relative distance being a measurement of a rate of change of a second distance between the vehicle and an object detected in the parallel lane; implementing the first fuzzy inference system to apply a speed control logic set of fuzzy logic rules to the first input of the first fuzzy inference system and the second input of the first fuzzy inference system to generate an output comprising a speed control recommendation; and implementing the second fuzzy inference system to apply a lane change logic set of fuzzy logic rules to the first input of the second fuzzy inference system, the second input of the second fuzzy inference system, and the third input of the second fuzzy inference system to generate a second output comprising a lane change recommendation.

In certain embodiments, one or both of the first fuzzy inference system and the second fuzzy inference system is a Mamdani fuzzy inference system. In certain embodiments, one or both of the first fuzzy inference system and the second fuzzy inference system is a Sugeno fuzzy inference system.

In certain embodiments, each of the first input, the second input, and the output of the first fuzzy inference system comprises five membership functions that are triangular in nature, wherein each of the first input and the second input of the second fuzzy inference system comprises three membership functions that are triangular or trapezoidal in nature, and the output of the second fuzzy inference system comprises four membership functions. In particular embodiments, the five membership functions of the first input of the first fuzzy inference system comprise variables of very small, small, perfect, large, and very large; the five membership functions of the second input of the first fuzzy inference system comprise variables of shrinking fast, shrinking, stable, growing, and growing fast; the five membership functions of the output of the first fuzzy inference system comprise variables of break hard, slow down, no action, speed up, and floor it; the three membership functions of the first input of the second fuzzy inference system comprise variables of right lane, middle lane, and left lane; the three membership functions of the second input of the second fuzzy inference system comprise variables of small, perfect, and large; the three membership functions of the third input of the second fuzzy inference system comprise variables of shrinking, stable, and growing; and the four membership functions of the output of the second fuzzy inference system comprise variables of right lane, middle lane, left lane, and no action. In particular embodiments, the speed control logic set of fuzzy logic rules includes 25 rules, and the lane change logic set of fuzzy logic rules includes 27 rules, wherein a first rule of the speed control logic set makes a determination based on the distance being very small and the relative distance shrinking fast that the vehicle should slow down quickly; a second rule of the speed control logic set makes a determination based on the distance being very small and the relative distance being stable that the vehicle should slow down; a third rule of the speed control logic set makes a determination based on the distance being very small and the relative distance being stable that the vehicle should slow down; a fourth rule of the speed control logic set makes a determination based on the distance being very small and the relative distance growing that the vehicle should make no change to speed; a fifth rule of the speed control logic set makes a determination based on the distance being very small and the relative distance growing fast that the vehicle should accelerate; a sixth rule of the speed control logic set makes a determination based on the distance being small and the relative distance growing fast that the vehicle should slow down; a seventh rule of the speed control logic set makes a determination based on the distance being small and the relative distance shrinking that the vehicle should slow down; an eighth rule of the speed control logic set makes a determination based on the distance being small and the relative distance being stable that the vehicle should slow down; a ninth rule of the speed control logic set makes a determination based on the distance being small and the relative distance growing that the vehicle should make no change in speed; a tenth rule of the speed control logic set makes a determination based on the distance being small and the relative distance growing fast that the vehicle should accelerate; an eleventh rule makes a determination based on the distance being perfect and the relative distance shrinking fast that the vehicle should slow down; a twelfth rule of the speed control logic set makes a determination based on the distance being perfect and the relative distance shrinking that the vehicle should slow down; a thirteenth rule of the speed control logic set makes a determination based on the distance being perfect and relative distance being stable that the vehicle should make no change in speed; a fourteenth rule of the speed control logic set makes a determination based on the distance being perfect and the relative distance growing that the vehicle should accelerate; a fifteenth rule of the speed control logic set makes a determination based on the distance being perfect and the relative distance growing fast that the vehicle should accelerate; a sixteenth rule of the speed control logic set makes a determination based on the distance being large and the relative distance shrinking fast that the vehicle should slow down; a seventeenth rule of the speed control logic set makes a determination based on the distance being large and the relative distance shrinking that the vehicle should make no change in speed; an eighteenth rule of the speed control logic set makes a determination based on the distance being large and the relative distance being stable that the vehicle should accelerate; a nineteenth rule of the speed control logic set makes a determination based on the distance being large and the relative distance growing that the vehicle should accelerate; a twentieth rule of the speed control logic set makes a determination based on the distance being large and the relative distance growing fast that the vehicle should accelerate quickly; a twenty-first rule of the speed control logic set makes a determination based on the distance being very large and the relative distance shrinking fast that the vehicle should slow down; a twenty-second rule of the speed control logic set makes a determination based on the distance being very large and the relative distance shrinking that the vehicle should make no change in speed; a twenty-third rule of the speed control logic set makes a determination based on the distance being very large and the relative distance being stable that the vehicle should accelerate; a twenty-fourth rule of the speed control logic set makes a determination based on the distance being very large and the relative distance growing that the vehicle should accelerate quickly; a twenty-fifth rule of the speed control logic set makes a determination based on the distance being very large and the relative distance growing fast that the vehicle should accelerate quickly; a first rule of the lane change logic set makes a determination based on the lane detection being right lane, the distance being small, and the relative distance shrinking that the vehicle should stay in its current lane; a second rule of the lane change logic set makes a determination based on the lane detection being right lane, the distance being small, and the relative distance being stable that the vehicle should stay in its current lane; a third rule of the lane change logic set makes a determination based on the lane detection being right lane, the distance being small, and the relative distance growing that the vehicle should stay in its current lane; a fourth rule of the lane change logic set makes a determination based on the lane detection being right lane, the distance being perfect, and the relative distance shrinking that the vehicle should stay in its current lane; a fifth rule makes a determination based on the lane detection being right lane, the distance being perfect, and the relative distance being stable that the vehicle should change to the right lane; a sixth rule of the lane change logic set makes a determination based on the lane detection being right lane, the distance being perfect, and the relative distance growing that the vehicle should change to the right lane; a seventh rule of the lane change logic set makes a determination based on the lane detection being right lane, the distance being large, and the relative distance shrinking that the vehicle should change to the right lane; an eighth rule of the lane change logic set makes a determination based on the lane detection being a right lane, the distance being large, and the relative distance being stable that the vehicle should change to the right lane; a ninth rule of the lane change logic set makes a determination based on the lane detection being right lane, the distance being large, and the relative distance growing that the vehicle should change to the right lane; a tenth rule of the lane change logic set makes a determination based on the lane detection being middle lane, the distance being small, and the relative distance shrinking that the vehicle should stay in its current lane; an eleventh rule of the lane change logic set makes a determination based on the lane detection being middle lane, the distance being small, and the relative distance being stable that the vehicle should stay in its current lane; a twelfth rule of the lane change logic set makes a determination based on the lane detection being middle lane, the distance being small, and the relative distance growing that the vehicle should change to the middle lane; a thirteenth rule of the lane change logic set makes a determination based on the lane detection being middle lane, the distance being perfect, and the relative distance shrinking that the vehicle should stay in its current lane; a fourteenth rule makes a determination based on the lane detection being middle lane, the distance being perfect, and the relative distance being stable that the vehicle should change to the middle lane; a fifteenth rule of the lane change logic set makes a determination based on the lane detection being middle lane, the distance being perfect, and the relative distance growing that the vehicle should change to the middle lane; a sixteenth rule of the lane change logic set makes a determination based on the lane detection being middle lane, the distance being large, and the relative distance shrinking that the vehicle should change to the middle lane; a seventeenth rule of the lane change logic set makes a determination based on the lane detection being middle lane, the distance being large, and the relative distance being stable that the vehicle should change to the middle lane; an eighteenth rule of the lane change logic set makes a determination based on the lane detection being middle lane, the distance being large, and the relative distance growing that the vehicle should change to the middle lane; a nineteenth rule of the lane change logic set makes a determination based on the lane detection being left lane, the distance being small, and the relative distance shrinking that the vehicle should stay in its current lane; a twentieth rule of the lane change logic set makes a determination based on the lane detection being left land, the distance being small, and the relative distance being stable that the vehicle should stay in its current lane; a twenty-first rule of the lane change logic set makes a determination based on the lane detection being left lane, the distance being small, and the relative distance growing that the vehicle should change to the left lane; a twenty-second rule of the lane change logic set makes a determination based on the lane detection being left lane, the distance being perfect, and the relative distance shrinking that the vehicle should stay in its current lane; a twenty-third rule of the lane change logic set makes a determination based on the lane detection being left lane, the distance being perfect, and the relative distance being stable that the vehicle should change to the left lane; a twenty-fourth rule of the lane change logic set makes a determination based on the lane detection being left lane, the distance being perfect, and the relative distance growing that the vehicle should change to the left lane; a twenty-fifth rule of the lane change logic set makes a determination based on the lane detection being left lane, the distance being large, and the relative distance shrinking that the vehicle should change to the left lane; a twenty-sixth rule of the lane change logic set makes a determination based on the lane detection being left lane, the distance being large, and the relative distance being stable that the vehicle should change to the left lane; and a twenty-seventh rule of the lane change logic set makes a determination based on the lane detection being left lane, the distance being large, and the relative distance growing that the vehicle should change to the left lane.

### BRIEF DESCRIPTION OF THE DRAWINGS

The patent or application file contains at least one drawing executed in color. Copies of this patent or patent application publication with color drawing(s) will be provided by the Office upon request and payment of the necessary fee.

FIG. 1: A block diagram of a first embodiment of a fuzzy inference system, referred to herein as fuzzy inference system 1 or FIS-1.

FIG. 2: A graph showing distance (input 1) membership functions of FIS-1.

FIG. 3: A graph showing relative distance (input 2) membership functions of FIS-1.

FIG. 4: A graph showing speed control (output) membership functions of FIS-1.

FIG. 5: A three-dimensional graph showing the distance, the relative distance, and the speed control of FIS-1.

FIG. 6: A block diagram of a second embodiment of a fuzzy inference system, referred to herein as fuzzy inference system 2 or FIS-2.

FIG. 7: A graph showing lane detection (input 1) membership functions of FIS-2.

FIG. 8: A graph showing distance (input 2) membership functions of FIS-2.

FIG. 9: A graph showing relative distance (input 3) membership functions of FIS-2.

FIG. 10: A graph showing lane change (output) membership functions of FIS-2.

FIG. 11: A three-dimensional graph showing the lane detection, the distance, and the lane change of FIS-2.

FIG. 12: A block diagram illustrating a third embodiment of a fuzzy inference system which combines the FIS-1 and FIS-2.

FIG. 13: A first illustration of an on-ramp scenario showing a vehicle on a ramp.

FIG. 14: A second illustration of the on-ramp scenario showing the vehicle merging into traffic.

FIG. 15: A first illustration of a traffic light scenario showing a vehicle at a red light.

FIG. 16: A second illustration of the traffic light scenario showing the vehicle at a green light.

FIG. 17: A first illustration of a lane closing scenario showing a vehicle approaching an obstacle.

FIG. 18: A second illustration of the lane closing scenario showing the vehicle merging to avoid the obstacle.

FIG. 19: An illustration of an up-hill scenario.

FIG. 20: An illustration of a circular road scenario.

FIG. 21: A graphical illustration of acceleration of a blue vehicle compared to the relative velocity.

FIG. 22: A rule view in MATLAB of an example of FIS-1 given a set of inputs.

FIG. 23: A Java software simulation illustration providing an output of FIS-1.

FIG. 24: A rule view in MATLAB of an example of FIS-2 given a set of inputs.

### DETAILED DESCRIPTION

Throughout this disclosure, various publications, patents, and published patent specifications are referenced by an identifying citation. The disclosures of these publications, patents, and published patent specifications are hereby incorporated by reference into the present disclosure in their entirety to more fully describe the state of the art to which this invention pertains.

Provided herein are fuzzy inference systems (FISs) configured to use fuzzy logic to mimic the reasoning of a driver in an autonomous vehicle. In a first embodiment, referred to herein as fuzzy inference system 1 or FIS-1, speed control is controlled. In a second embodiment, referred to herein as fuzzy inference system 2 or FIS-2, lane changing is controlled. In a third embodiment, referred to herein as fuzzy inference system 3 or FIS-3, both speed control and lane changing are controlled. The fuzzy inference systems may be incorporated into an autonomous vehicle which can be considered a level 2 or higher autonomous vehicle.

The term “subject vehicle” as used herein refers to a vehicle which is using a fuzzy inference system to control speed control, lane changing, or both speed control and lane changing. In some embodiments, the fuzzy inference system may make one or more recommendations, and the subject vehicle may or may not act on the recommendations from the fuzzy inference system.

Fuzzy logic accepts things that can be partly true and partly false at the same time. Fuzzy logic is based on fuzzy set theory, and it mimics the human decision-making process. Fuzzy logic reflects how people think by attempting to model people's sense of words, decision making, and common sense. As a result, fuzzy logic is useful for creating more human and intelligent systems. A fuzzy inference system is the process of mapping an input to its output. There are several fuzzy inference systems available. Non-limiting examples of fuzzy inference systems include the Mamdani fuzzy inference system and the Sugeno fuzzy inference system.

The Mamdani fuzzy inference system has widespread acceptance because of its more interpretable rule base. The Mamdani fuzzy inference system is more intuitive than other systems and can mimic the human mind. The output of the Mamdani fuzzy inference system is given as a fuzzy set which is then defuzzied to obtain a crisp value. The Mamdani fuzzy inference system has three steps: fuzzification, rule evaluation, and defuzzification. Fuzzification is the process of turning a crisp value into a fuzzy set, so that it can be used and analyzed using a fuzzy inference mechanism. The inputs and outputs of the design are assigned linguistic variables and some degrees of membership.

Rule evaluation in a Mamdani fuzzy inference system uses If—Then rules to determine the output of a fuzzy set. For each rule, fuzzy implication is introduced in the form of an AND operation which belongs to the Mamdani technique minimum function which initializes the output set that is used to make decisions that are relied on by checking all the rules specified in the fuzzy structure. The decisions can be a combination of outputs from the output set.

De-fuzzification is the process of acquiring the crisp or quantified value regarding rule inferencing and interconnection from fuzzy sets. The fuzzy inference system model analyzes all relevant rules with respect to the membership features and input values. The input from the rule base is then mapped to the output function for membership. The centroid-based de-fuzzification technique is used to convert the mapped results from every rule into a crisp value. The centroid defuzzification approach determines the balance point of the fuzzy region solution by measuring the weighted mean of the fuzzy region output.

Sugeno fuzzy logic, also known as Takagi-Sugeno-Kang fuzzy logic, uses singleton output membership functions that are either a continuous or linear input value function. This type of fuzzy logic is much more complex than Mamdani fuzzy logic, and can lead to complications. However, it is nonetheless possible to use Sugeno fuzzy logic in the fuzzy inference systems described herein.

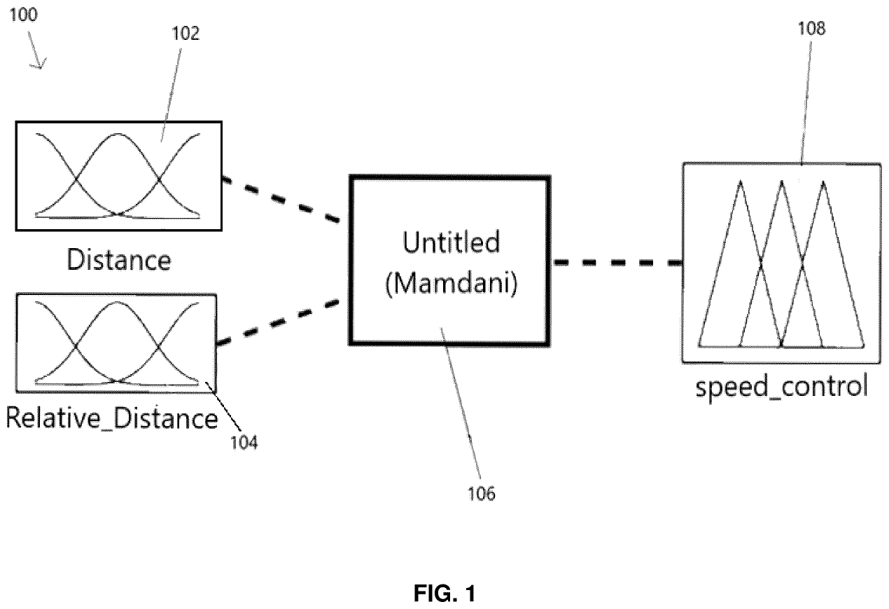

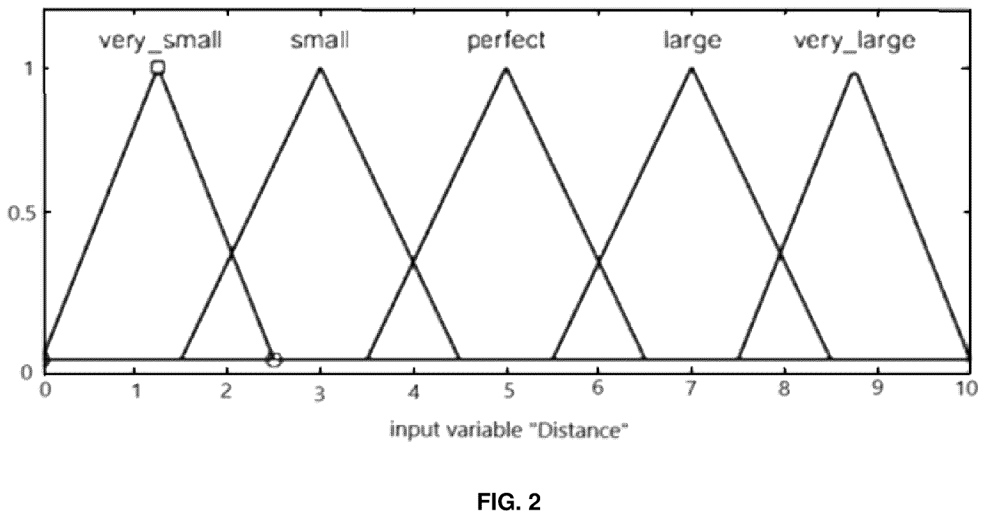

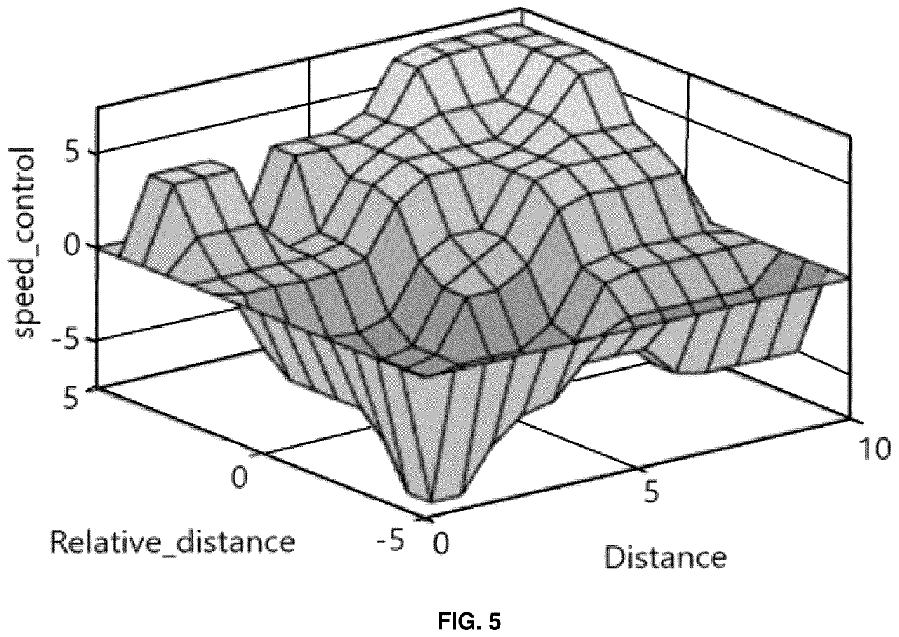

Referring now to FIGS. 1-5, a first fuzzy inference system (“FIS-1”) 100 block diagram is depicted in FIG. 1, and membership functions associated with inputs and outputs of FIS-1 100 are depicted in FIGS. 2-5. FIS-1 100 may include a first input 102 which is defined by a distance. The distance can be a measurement between a front vehicle (i.e., a vehicle in front of the subject vehicle) and the subject vehicle occupied by a driver. The distance can be measured, for example, with a distance sensor attached to the subject vehicle.

Referring still to FIGS. 1-5, the first input 102 can have five membership functions. The membership functions can include the following variables: very small (VSm), small (Sm), perfect (p), large (L), or very large (VL). The distance recorded in the very small variable is the smallest distance, and the distance recorded in the very large variable is the largest distance. The distance recorded in the small variable is larger than the distance recorded in the very small variable. The distance recorded in the large variable is smaller than the distance recorded in the very large variable. The distance recorded in the perfect variable is between the distance recorded in the small variable and the distance recorded in the large variable.

The first input 102 of FIS-1 100, the distance as shown in FIG. 2, has membership functions which are triangular in nature when viewed on a membership function plot. This triangular nature allows for the membership functions to overlap, which aids in improving decision making in the FIS-1 100. As seen in FIG. 2, each of the membership functions associated with the first input 102 can have the values of very small [0, 1.25, 2.5], small [1.5, 3, 4.5], perfect [3.5, 5, 6.5], large [5.5, 7, 8.5] and very large [7.5, 8.75, 10], where each bracketed set of values defines a minimum distance value, an intermediate distance value, and a maximum distance value that define a range of values associated with the corresponding membership function.

Referring still to FIGS. 1-5, FIS-1 100 may also include a second input 104 which is defined by a relative distance. The relative distance can be a measurement of a changing distance between the subject vehicle and a vehicle in front of the subject vehicle. The second input 104 can have five membership functions. The membership functions can include the following variables: shrinking fast (ShF), shrinking (Sh), stable (St), growing (G), and growing fast (GF). The relative distance is shrinking the fastest under the variable shrinking fast, and the relative distance is growing the fastest under the variable growing fast. The relative distance associated with the variable shrinking is growing faster than the relative distance associated with the variable shrinking fast. The relative distance associated with the variable growing is growing less slowly than the relative distance associated with the variable growing fast. The relative distance associated with the variable stable is growing at a rate between the relative distance associated with the variable shrinking and the relative distance associated with the variable growing.

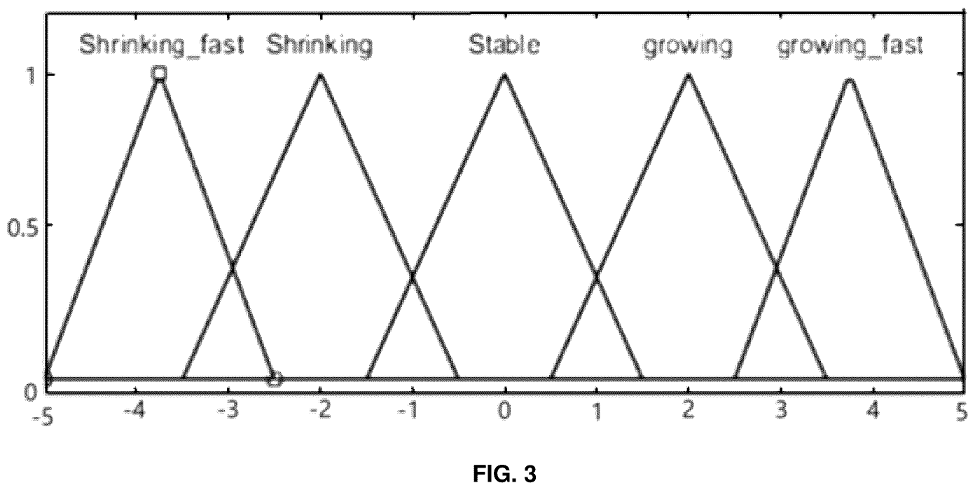

The second input 104, the relative distance as shown in FIG. 3, has the five membership functions which are triangular in nature when viewed on a membership function plot. This triangular nature allows for the membership functions to overlap, which aids in improving decision making in the FIS-1 100. Each of the membership functions associated with the second input 104 can have the values of: shrinking fast [−5, 3.75, −2.5], shrinking [−3.5, −2, −0.5], stable [−1.5, 0, 1.5], growing [0.5, 2, 3.5], and growing fast [2.5, 3.75, 5], where each bracketed set of the values defines a minimum value, an intermediate value, and a maximum value that define a range of values associated with the corresponding membership function. It is understood that each of the two inputs may utilize a different sensor to obtain the necessary values for the inputs.

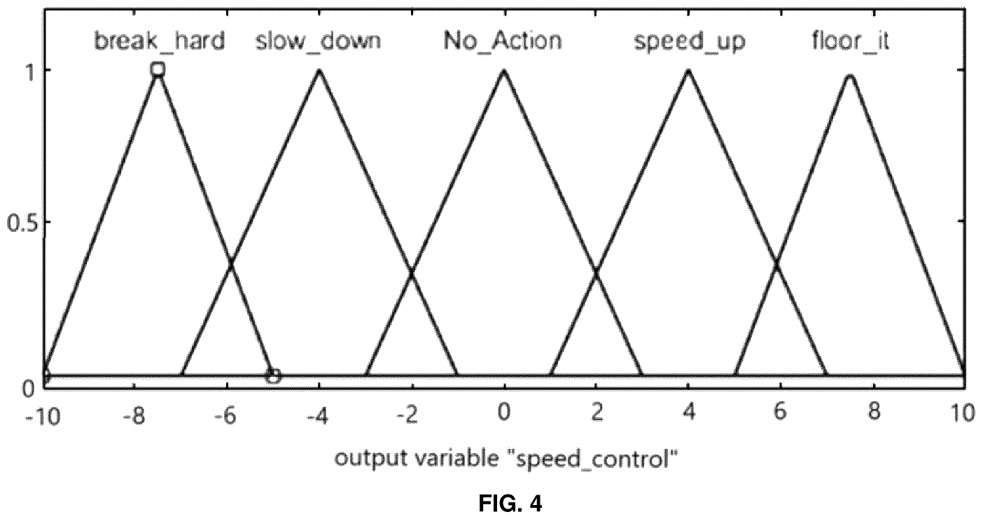

Referring still to FIGS. 1-5, FIS-1 100 may also include an output 108 which is defined by speed control. The speed control can be a value of acceleration or a value of breaking. The output 108 may have five membership functions. These functions can include break hard (BH), slow down (SD), no action (NA), speed up (SU), and floor it (FI). The break hard membership function can be an indication of applying the break heavily to slow the car down. The slow down membership function can be an indication of applying the break in a manner less than that compared to the break hard function. The no action membership function is an indication that the subject vehicle should not break or accelerate. The speed up membership function is an indication that the subject vehicle should accelerate. The floor it membership function is an indication that the subject vehicle should accelerate at a faster rate in comparison to the speed up membership function. The output 108, the speed control as shown in FIG. 4, has the five membership functions which can be triangular in nature when viewed on a membership function plot. This triangular nature allows for the membership functions to overlap, which aids in improving decision making in the FIS-1 100. Each membership function associated with the output 108 can have the values of: break hard [−10, −7.5, −5], slow down [−7, −4, −1], no action [−3, 0, 3], speed up [1, 4, 7] and floor it [5, 7.5, 10], where each bracketed set of the values defines a minimum value, an intermediate value, and a maximum value that define a range of values associated with the corresponding membership function.

Referring still to FIGS. 1-5, the first input 102 and the second input 104 can be used to design fuzzy rules 106 that are created to provide the output 108 of FIS-1 100 from the first input 102 and the second input 104. The first input 102 having five membership functions and the second input 104 having five membership functions creates an embodiment with twenty-five fuzzy rules 106. In this non-limiting example, the twenty-five fuzzy rules 106 are as follows:
1) If (Distance is very small) and (Relative distance is shrinking fast) then (Speed control is break hard).
2) If (Distance is very small) and (Relative distance is stable) then (Speed control is slow down).
3) If (Distance is very small) and (Relative distance is stable) then (Speed control is slow down).
4) If (Distance is very small) and (Relative distance is growing) then (Speed control is no action).
5) If (Distance is very small) and (Relative distance is growing fast) then (Speed control is speed up).
6) If (Distance is small) and (Relative distance is growing fast) then (Speed control is slow down).
7) If (Distance is small) and (Relative distance is shrinking) then (Speed control is slow down).
8) If (Distance is small) and (Relative distance is stable) then (Speed control is slow down).
9) If (Distance is small) and (Relative distance is growing) then (Speed control is no action).
10) If (Distance is small) and (Relative distance is growing fast) then (Speed control is speed up).
11) If (Distance is perfect) and (Relative distance is shrinking fast) then (Speed control is slow down).
12) If (Distance is perfect) and (Relative distance is shrinking) then (Speed control is slow down).
13) If (Distance is perfect) and (Relative distance is stable) then (Speed control is no action).
14) If (Distance is perfect) and (Relative distance is growing) then (Speed control is speed up).
15) If (Distance is perfect) and (Relative distance is growing fast) then (Speed control is speed up).
16) If (Distance is large) and (Relative distance is shrinking fast) then (Speed control is slow down).
17) If (Distance is large) and (Relative distance is shrinking) then (Speed Control is no action).
18) If (Distance is large) and (Relative distance is stable) then (Speed control is speed up).
19) If (Distance is large) and (Relative distance is growing) then (Speed control is speed up).
20) If (Distance is large) and (Relative distance is growing fast) then (Speed control is floor it).
21) If (Distance is very large) and (Relative distance is shrinking fast) then (Speed control is slow down).
22) If (Distance is very large) and (Relative distance is shrinking) then (Speed control is no action).
23) If (Distance is very large) and (Relative distance is stable) then (Speed control is speed up).
24) If (Distance is very large) and (Relative distance is growing) then (Speed control is floor it).
25) If (Distance is very large) and (Relative distance is growing fast) then (Speed control is floor it).

The twenty-five fuzzy rules 106 each include an if-then statement where the “then” statement describes an action that the subject vehicle should take based on the “if” statement. In this embodiment, the actions are described according to the following. Rule 1 makes a determination based on the distance being very small and the relative distance shrinking fast that the subject vehicle should slow down quickly. Rule 2 makes a determination based on the distance being very small and the relative distance being defined as stable that the subject vehicle should slow down. Rule 3 makes a determination based on the distance being very small and the relative distance being stable that the subject vehicle should slow down. Rule 4 makes a determination based on the distance being very small and the relative distance growing that the subject vehicle should make no change to speed. Rule 5 makes a determination based on the distance being very small and the relative distance growing fast that the subject vehicle should accelerate. Rule 6 makes a determination based on the distance being small and the relative distance growing fast that the subject vehicle should slow down. Rule 7 makes a determination based on the distance being small and the relative distance shrinking that the subject vehicle should slow down. Rule 8 makes a determination based on the distance being small and the relative distance being stable that the subject vehicle should slow down. Rule 9 makes a determination based on the distance being small and the relative distance growing that the subject vehicle should make no change in speed. Rule 10 makes a determination based on the distance being small and the relative distance growing fast that the subject vehicle should accelerate. Rule 11 makes a determination based on the distance being perfect and the relative distance shrinking fast that the subject vehicle should slow down. Rule 12 makes a determination based on the distance being perfect and the relative distance shrinking that the subject vehicle should slow down. Rule 13 makes a determination based on the distance being perfect and relative distance being stable that the subject vehicle should make no change in speed. Rule 14 makes a determination based on the distance being perfect and the relative distance growing that the subject vehicle should accelerate. Rule 15 makes a determination based on the distance being perfect and the relative distance growing fast that the subject vehicle should accelerate. Rule 16 makes a determination based on the distance being large and the relative distance shrinking fast that the subject vehicle should slow down. Rule 17 makes a determination based on the distance being large and the relative distance shrinking that the subject vehicle should make no change in speed. Rule 18 makes a determination based on the distance being large and the relative distance being stable that the subject vehicle should accelerate. Rule 19 makes a determination based on the distance being large and the relative distance growing that subject vehicle should accelerate. Rule 20 makes a determination based on the distance being large and the relative distance growing fast that the subject vehicle should accelerate quickly. Rule 21 makes a determination based on the distance being very large and the relative distance shrinking fast that the subject vehicle should slow down. Rule 22 makes a determination based on the distance being very large and the relative distance shrinking that the subject vehicle should make no change in speed. Rule 23 makes a determination based on the distance being very large and the relative distance being stable that the subject vehicle should accelerate. Rule 24 makes a determination based on the distance being very large and the relative distance growing that the subject vehicle should accelerate quickly. Rule 25 makes a determination based on the distance being very large and the relative distance growing fast that the subject vehicle should accelerate quickly.

Referring still to FIGS. 1-5, the FIS-1 100 includes the first input 102, the second input 104, the twenty-five fuzzy rules 106, and the output 108. The FIS-1 100 applies the twenty-five rules 160 to the membership values of the first input 102 and the second input 104 to obtain a de-fuzzified output identified as the output 108 in FIG. 1. The “AND” operator used in the twenty-five fuzzy rules 106 takes a minimum value of two membership functions, one from the first input 102 and one from the second input 104, to give the output 108 in the membership function form as shown in FIG. 4. The output 108 is a recommendation relating to speed control of the subject vehicle, which in some embodiments the subject vehicle acts on autonomously, and in other embodiments, the subject vehicle presents to the driver for the driver to make a decision relating to speed control.

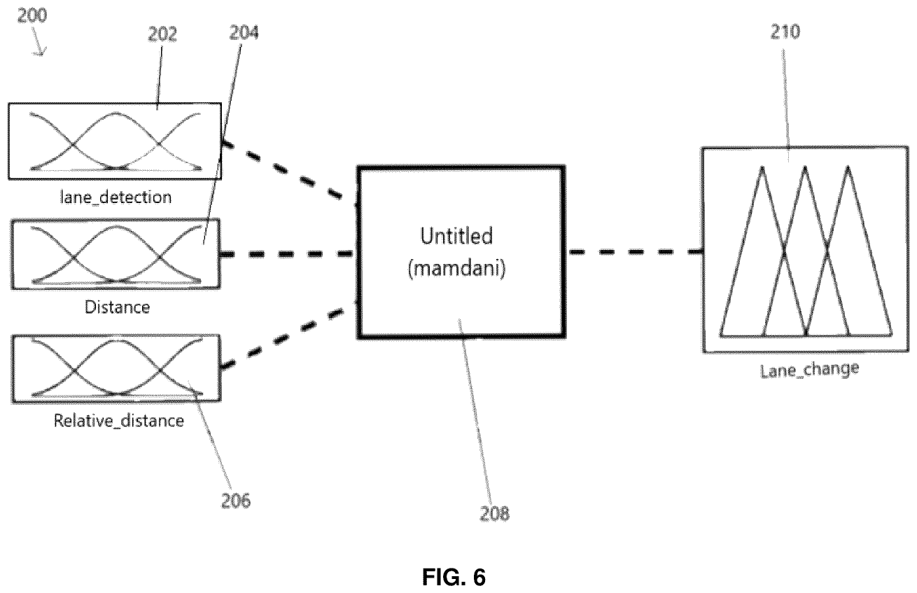

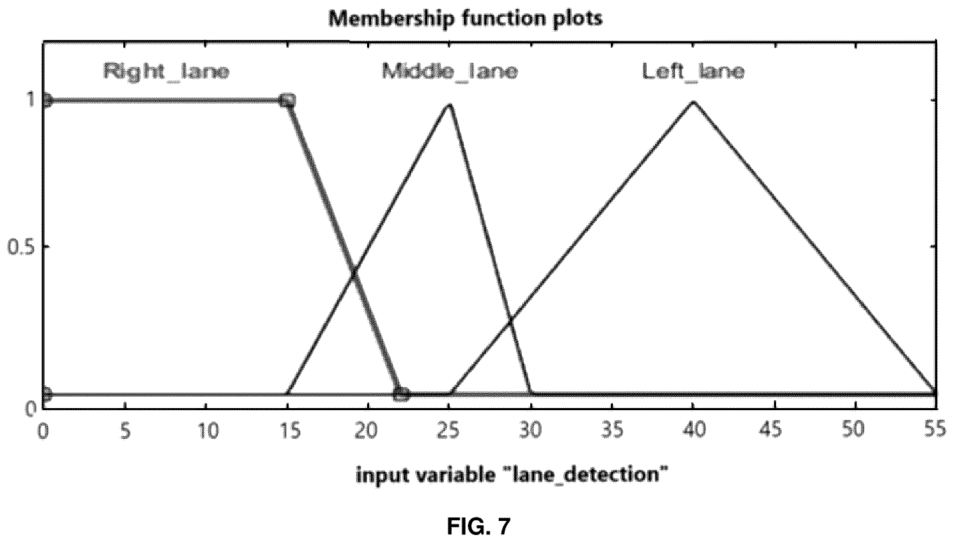

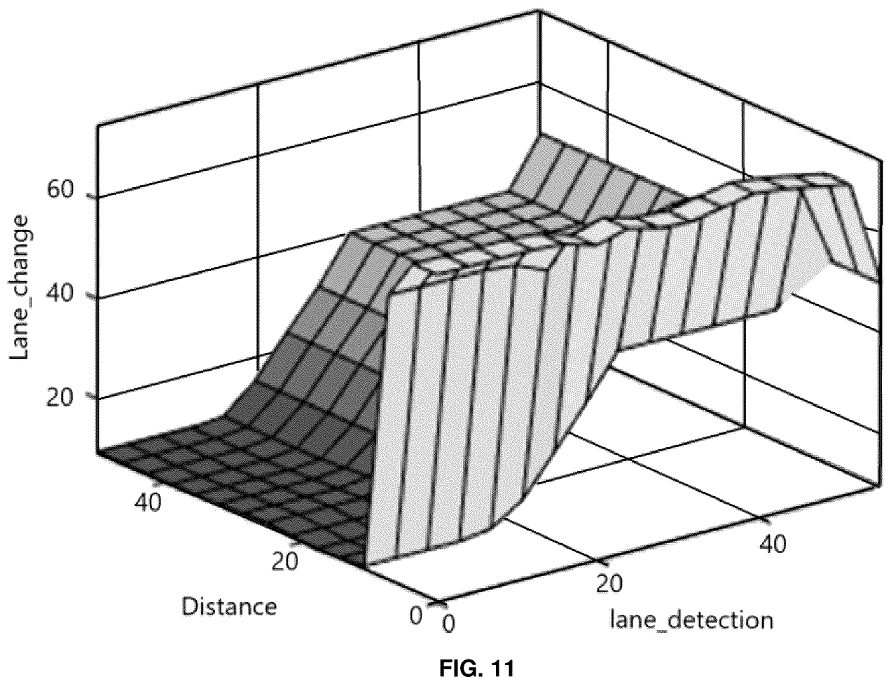

Referring now to FIGS. 6-11, a second fuzzy inference system (“FIS-2”) 200 block diagram is depicted in FIG. 6, and membership functions associated with inputs and outputs of the FIS-2 200 are depicted in FIGS. 7-10. FIS-2 200 may include a first input 202 which is defined by lane detection. The lane detection is the detection of a parallel lane to which the subject vehicle is considering entering as part of a change of lanes. The first input 202 of FIS-2 200 can have three membership functions. The membership functions can include the following variables: right lane (Rl), middle lane (Ml), and left lane (Ll). These variables are defined relative to the lane in which the subject vehicle is presently in. For example, the variable right lane represents a lane that is directly right of the subject vehicle. The first input 202 of FIS-2 200, which is the lane detection as shown in FIG. 7, has the three membership functions which can be defined as triangular or trapezoidal when viewed on a membership function plot. This allows for the membership functions to overlap which aids in improving decision making in the FIS-2 200. As seen in FIG. 7, each membership function associated with the first input 202 of FIS-2 200 can have the values of: right lane [0, 0, 15, 22], middle lane [15, 25, 30], and left lane [25, 40, 55], where each bracketed set of the values defines a minimum value, an intermediate value, and a maximum value that define a range of values associated with the corresponding membership function. However, a membership function that is trapezoidal in nature has an extra value which can be the same as either the maximum value or the minimum value.

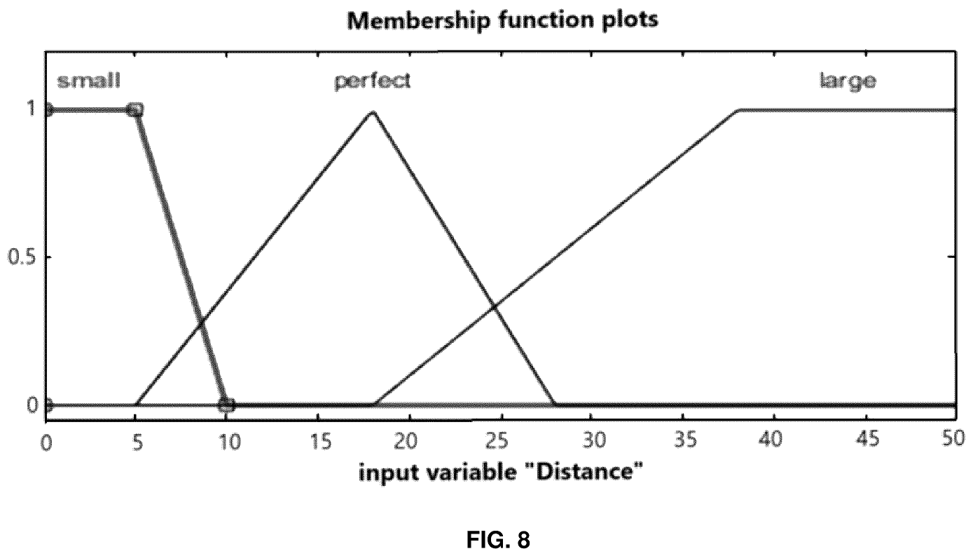

Referring still to FIGS. 6-11, FIS-2 200 may also include a second input 204 which is defined by a distance. The distance can be a measurement of the space between the front vehicle and the subject vehicle as described previously. The distance can be measured using a distance sensor attached to, or otherwise incorporated into, the subject vehicle. The second input 204 of FIS-2 200 can have three membership functions. The membership functions can include the variables small (S), perfect (P), and large (L). The distance recorded in the small variable is the smallest distance, and the distance recorded in the large variable is the largest distance. The distance recorded in the perfect variable is between the distance recorded in the small variable and the distance recorded in the large variable. The second input 204 of FIS-2 200, the distance as shown in FIG. 8, has the three membership functions which can be defined as triangular or trapezoidal when viewed on a membership function plot. This allows for the membership functions to overlap which aids in improving decision making in the FIS-2 200. As seen in FIG. 8, each membership function associated with the second input 204 of FIS-2 200 can have the values of: small [0, 0, 5, 10], perfect [5, 18, 28], and large [18, 38, 50, 50], where each bracketed set of the values defines a minimum value, an intermediate value, and a maximum value that defines a range of values associated with the corresponding membership function. However, a membership function that is trapezoidal in nature has an extra value which can be the same as either the maximum value or the minimum value.

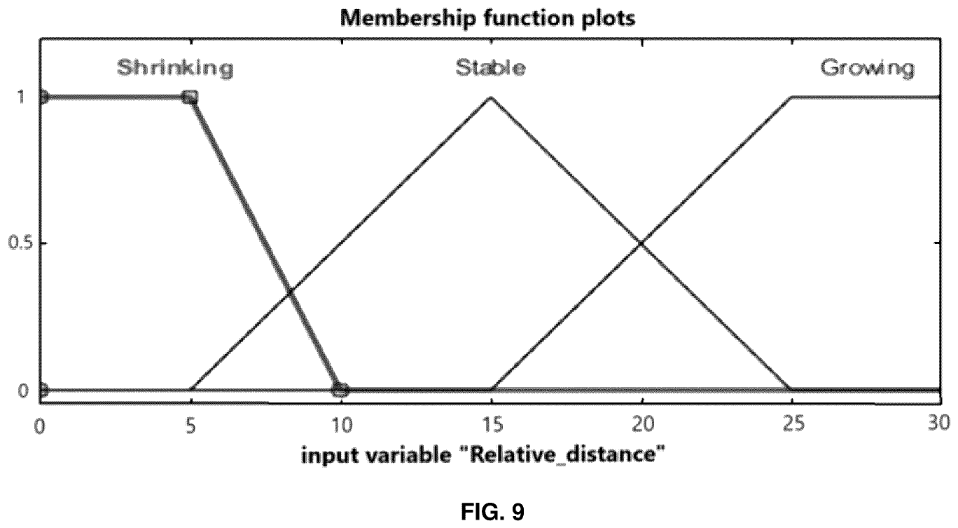

Referring still to FIGS. 6-11, the FIS-2 200 may also include a third input 206 which is defined by a relative distance of FIS-2 200. The relative distance of FIS-2 200 can be a measurement of the changing distance between the subject vehicle and the vehicle detected in the parallel lane. The third input 206 of FIS-2 can have three membership functions. These functions can include the variables shrinking (Sh), stable (St), and growing (G). The relative distance is shrinking under the variable shrinking and the relative distance is growing under the variable growing. The relative distance is neither appreciably shrinking nor appreciably growing under the variable stable. The third input 206 of FIS-2 200, which is the relative distance of FIS-2 200 as shown in FIG. 9, has the three membership functions that can be defined as triangular or trapezoidal when viewed on a membership function plot. This allows for the membership functions to overlap which aids in improving decision making in the FIS-2 200. As seen in FIG. 9, each membership function associated with the third input 206 of FIS-2 200 can have the values of: shrinking [0, 0, 5, 10], stable [5, 15, 25], and growing [15, 25, 30, 30], where each bracketed set of the values defines a minimum value, an intermediate value, and a maximum value that defines a range of values associated with the corresponding membership function. However, a membership function that is trapezoidal in nature has an extra value in which can be the same as either the maximum value or the minimum value. It shall be understood that each of the three inputs 202, 204, 206 may utilize a different sensor to obtain the necessary values for the inputs 202, 204, 206.

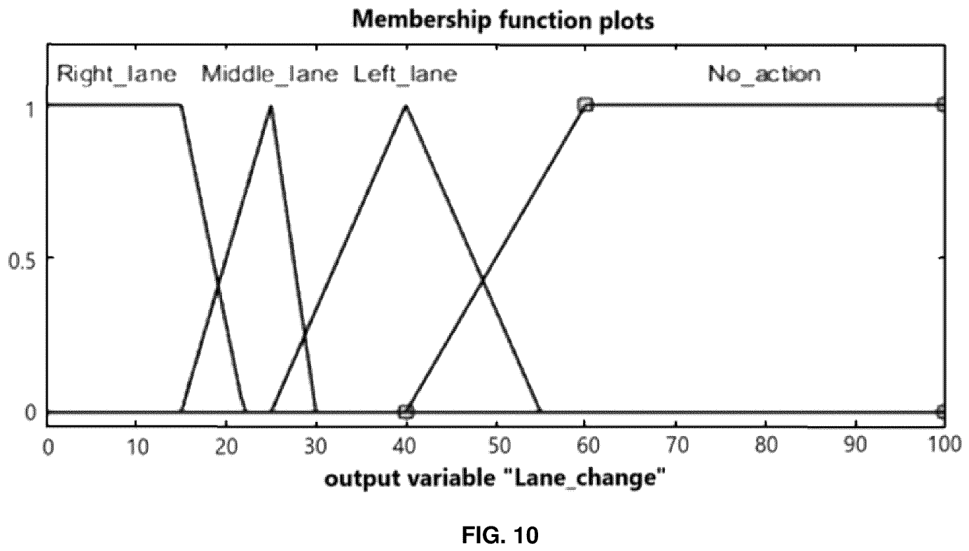

Referring still to FIGS. 6-11, the FIS-2 200 may also include an output 210 which is defined by a lane change. The lane change provides a recommendation on whether the subject vehicle should change to a desired lane. The output 210 of the FIS-2 200 may have four membership functions. These functions can include the variables right lane (RL), middle lane (MI), left lane (Ll) and no action (NA). These variables are relative to the lane in which the subject vehicle is presently. The variable right lane is a lane which is to the right of the subject vehicle and indicates the subject vehicle should change lanes into the right lane. The left lane is a lane which is to the left of the subject vehicle and indicates the subject vehicle should change lanes into the left lane. The middle lane is a lane which is in the middle of the road on which the subject vehicle is driving and indicates the subject vehicle should change lanes into the middle lane. The variable no action indicates the car should take no action with respect to switching lanes. The output 210, which is the lane change as shown in FIG. 10, has four membership functions that can be triangular or trapezoidal in nature when viewed on a membership function plot. This allows for the membership functions to overlap which aids in improving decision making in the FIS-2 200. As seen in FIG. 10, each membership function associated with the output 210 of FIS-2 200 can have the values of: right lane [0, 0, 15, 22], middle lane [15, 25, 30], left lane [25, 40, 55], and no action [40, 60, 100, 100], where each bracketed set of the values defines a minimum value, an intermediate value, and a maximum value that defines a range of values associated with the corresponding membership function. However, a membership function that is trapezoidal in nature has an extra value which can be the same as either the maximum value or the minimum value.

Referring still to FIGS. 6-11, the first input 202, the second input 204, and the third input 206 of the FIS-2 200 can be used to design twenty-seven fuzzy rules 208 that generate the output 210. The first input 202 having three membership functions, the second input 204 having three membership functions, and the third input 206 having three membership functions creates an embodiment with the twenty-seven fuzzy rules 208. In this non-limiting example embodiment, the twenty-seven fuzzy rules 208 are as follows:
1) If (Lane detection is right lane) and (Distance is small) and (Relative distance is shrinking) then (Lane change is no action).
2) If (Lane detection is right lane) and (Distance is small) and (Relative distance is stable) then (Lane change is no action).
3) If (Lane detection is right lane) and (Distance is small) and (Relative distance is growing) then (Lane change is no action).
4) If (Lane detection is right lane) and (Distance is perfect) and (Relative distance is shrinking) then (Lane change is no action).
5) If (Lane detection is right lane) and (Distance is perfect) and (Relative distance is stable) then (Lane change is right lane).
6) If (Lane detection is right lane) and (Distance is perfect) and (Relative distance is growing) then (Lane change is right lane).
7) If (Lane detection is right lane) and (Distance is large) and (Relative distance is shrinking) then (Lane change is right lane).
8) If (Lane detection is right lane) and (Distance is large) and (Relative distance is stable) then (Lane change is right lane).
9) If (Lane detection is right lane) and (Distance is large) and (Relative distance is growing) then (Lane change is right lane).
10) If (Lane detection is middle lane) and (Distance is small) and (Relative distance is shrinking) then (Lane change is no action).
11) If (Lane detection is middle lane) and (Distance is small) and (Relative distance is stable) then (Lane change is no action).
12) If (Lane detection is middle lane) and (Distance is small) and (Relative distance is growing) then (Lane change is middle lane).
13) If (Lane detection is middle lane) and (Distance is perfect) and (Relative distance is shrinking) then (Lane change is no action).
14) If (Lane detection is middle lane) and (Distance is perfect) and (Relative distance is stable) then (Lane change is middle lane).
15) If (Lane detection is middle lane) and (Distance is perfect) and (Relative distance is growing) then (Lane change is middle lane).
16) If (Lane detection is middle lane) and (Distance is large) and (Relative distance is shrinking) then (Lane change is middle lane).
17) If (Lane detection is middle lane) and (Distance is large) and (Relative distance is stable) then (Lane change is middle lane).
18) If (Lane detection is middle lane) and (Distance is large) and (Relative distance is growing) then (Lane change is middle lane).
19) If (Lane detection is left lane) and (Distance is small) and (Relative distance is shrinking) then (Lane change is no action).
20) If (Lane detection is left lane) and (Distance is small) and (Relative distance is stable) then (Lane change is no action).
21) If (Lane detection is left lane) and (Distance is small) and (Relative distance is growing) then (Lane change is left lane).
22) If (Lane detection is left lane) and (Distance is perfect) and (Relative distance is shrinking) then (Lane change is no action).
23) If (Lane detection is left lane) and (Distance is perfect) and (Relative distance is stable) then (Lane change is left lane).
24) If (Lane detection is left lane) and (Distance is perfect) and (Relative distance is growing) then (Lane change is left lane).
25) If (Lane detection is left lane) and (Distance is large) and (Relative distance is shrinking) then (Lane change is left lane).
26) If (Lane detection is left lane) and (Distance is large) and (Relative distance is stable) then (Lane change is left lane).
27) If (Lane detection is left lane) and (Distance is large) and (Relative distance is growing) then (Lane change is left lane).

The twenty-seven fuzzy rules 208 determine actions that the subject vehicle should take based on the inputs 202, 204, 206. These actions are described according to the following. Rule 1 makes a determination based on lane detection being a right lane, distance being small, and the relative distance shrinking that the subject vehicle should stay in its current lane. Rule 2 makes a determination based on lane detection being a right lane, distance being small, and relative distance being stable that the subject vehicle should stay in its current lane. Rule 3 makes a determination based on lane detection being a right lane, distance being small, and relative distance growing that the subject vehicle should stay in its current lane. Rule 4 makes a determination based on lane detection being a right lane, distance being perfect, and relative distance shrinking that the subject vehicle should stay in its current lane. Rule 5 makes a determination based on lane detection being a right lane, distance being perfect, and relative distance being stable that the subject vehicle should change to the right lane. Rule 6 makes a determination based on lane detection being a right lane, distance being perfect, and relative distance growing that the subject vehicle should change to the right lane. Rule 7 makes a determination based on lane detection being a right lane, distance being large, and relative distance shrinking that the subject vehicle should change to the right lane. Rule 8 makes a determination based on lane detection being a right lane, distance being large, and relative distance being stable that the subject vehicle should change to the right lane. Rule 9 makes a determination based on lane detection being a right lane, distance being large, and relative distance growing that the subject vehicle should change to the right lane. Rule 10 makes a determination based on lane detection being a middle lane, distance being small, and relative distance shrinking that the subject vehicle should stay in its current lane. Rule 11 makes a determination based on lane detection being a middle lane, distance being small, and relative distance being stable that the subject vehicle should stay in its current lane. Rule 12 makes a determination based on lane detection being a middle lane, distance being small, and relative distance growing that the subject vehicle should change to the middle lane. Rule 13 makes a determination based on lane detection being a middle lane, distance being perfect, and relative distance shrinking that the subject vehicle should stay in its current lane. Rule 14 makes a determination based on lane detection being a middle lane, distance being perfect, and relative distance being stable that the subject vehicle should change to the middle lane. Rule 15 makes a determination based on lane detection being a middle lane, distance being perfect, and relative distance growing to result that the subject vehicle should change to the middle lane. Rule 16 makes a determination based on lane detection being a middle lane, distance being large, and relative distance shrinking that the subject vehicle should change to the middle lane. Rule 17 makes a determination based on lane detection being a middle lane, distance being large, and relative distance being stable that the subject vehicle should change to the middle lane. Rule 18 makes a determination based on lane detection being a middle lane, distance being large, and relative distance growing that the subject vehicle should change to the middle lane. Rule 19 makes a determination based on lane detection being a left lane, distance being small, and relative distance shrinking that the subject vehicle should stay in its current lane. Rule 20 makes a determination based on lane detection being a left land, distance being small, and relative distance being stable that the subject vehicle should stay in its current lane. Rule 21 makes a determination based on lane detection being a left lane, distance being small, and relative distance growing that the subject vehicle should change to the left lane. Rule 22 makes a determination based on lane detection being a left lane, distance being perfect, and relative distance shrinking that the subject vehicle should stay in its current lane. Rule 23 makes a determination based on lane detection being a left lane, distance being perfect, and relative distance being stable that the subject vehicle should change to the left lane. Rule 24 makes a determination based on lane detection being a left lane, distance being perfect, and relative distance growing that the subject vehicle should change to the left lane. Rule 25 makes a determination based on lane detection being a left lane, stance being large, and relative distance shrinking that the subject vehicle should change to the left lane. Rule 26 makes a determination based on lane detection being a left lane, distance being large, and relative distance being stable that the subject vehicle should change to the left lane. Rule 27 makes a determination based on lane detection being a left lane, distance being large, and relative distance growing that the subject vehicle should change to the left lane.

Referring still to FIGS. 6-11, the FIS-2 200 comprises the first input 202, the second input 204, the third input 206, the twenty-seven fuzzy rules 208, and the output 210. It should be noted that any number of sensors (e.g., one, two, or three different sensors) may be utilized to obtain the first input 202, the second input 204, and the third input 206. The FIS-2 200 applies the twenty-seven fuzzy rules 208 to the membership values of the first input 202, the second input 204, and the third input 206 to obtain a de-fuzzified output identified as the output 208 in FIG. 6. The “AND” operator used in the twenty-seven fuzzy rules 208 takes the minimum value of three membership functions, one from the first input 202, one from the second input 204, and one from the third input 206, to give the output 210 as a membership function as shown in FIG. 10. The output 208 is a recommendation relating to lane changing of the subject vehicle, which in some embodiments the subject vehicle acts on autonomously, and in other embodiments, the subject vehicle presents to the driver for the driver to make a decision relating to lane changing.

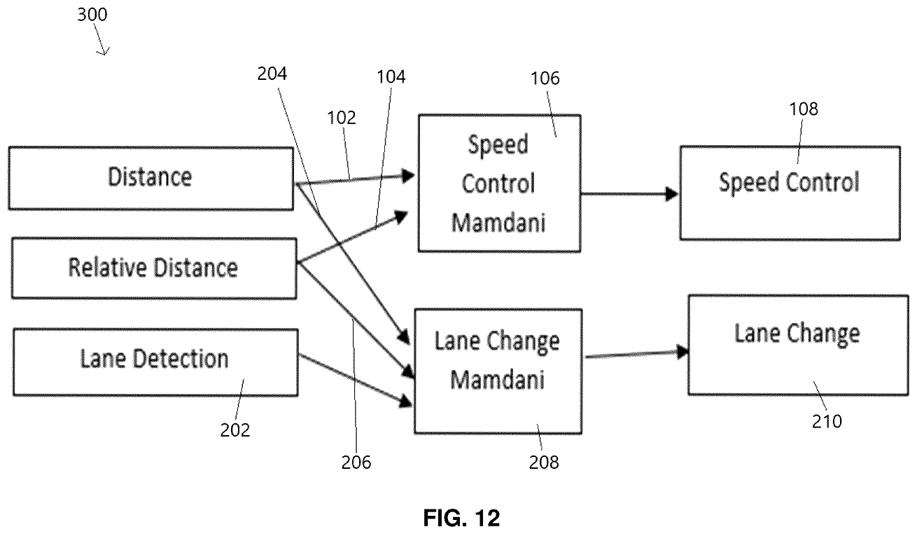

Referring now to FIG. 12, illustrated is a block diagram of a combined fuzzy inference system 300 using FIS-1 100 and FIS-2 200. The combined fuzzy inference system (“FIS-3”) 300 uses inputs and outputs of FIS-1 100 and FIS-2 200 to produce a system which can control, or at least make recommendations regarding, speed and change lanes. The first input 102 of FIS-1 100 and the second input 104 of FIS-1 100 can be used in the speed control Mamdani (i.e., the twenty-five fuzzy rules 106) to produce the output 108 of FIS-1 100 relating to speed control. In conjunction with the preceding inputs, the first input 202 of FIS-2 200, the second input 201 of FIS-2 200, and the third input 206 of FIS-2 200 are incorporated into the combined system 300. These inputs 202, 204, 206 are used in a lane change Mamdani (i.e., the twenty-seven fuzzy rules 208) to produce the output 210 of FIS-2 relating to lane changing. The combined system 300 thus uses both FIS-1 100 and FIS-2 200 in order to create a system which can both adjust speed of an autonomous vehicle and change lanes of the autonomous vehicle regardless of the number of lanes that are present, or at least make recommendations regarding speed control and lane changes which the subject vehicle may present to the driver.

### EXAMPLES

Forward collision and lane changing aspects of a vehicle assistance system were designed using the Java Swings interface. This process integrated fuzzy logic to determine the fuzzy rules for lane changing and acceleration. The lanes were created with java frames and each lane was defined with different sizes. Multiple vehicles such as trucks and vehicles were created, and lane changing factors were defined with different speed range factors. The background and foreground were defined to represent the different events. The microstreet class defines the vehicle movable representation and the vehicle lane class defines the adjustment methods and canvas methods. The basic advantage of the movable objects is properly integrated in java with the defined features of vectors, random, and canvas. A sorting routine sort for rearranging the vehicle order is defined with the adjustment methods.

The user has different choices to organize the different scenarios to evaluate the performance of the system, and the fuzzy rules were defined with each scenario. The java program simulates a lane change scenario and forwarding scenarios by considering different track length units and organizes three different lanes across. The subject vehicle is defined with a few basic functions such as moving forward, changing between lanes, checking traffic across the next lane, etc. The vehicles are defined with initial speed, and the speed adjustment controller adjusts the speeds. The subject vehicle's speed was defined by considering the current position of the object.

In these examples, a MicroSim model using Java was developed to design an automated driving system with different scenarios. The different scenarios included uphill, traffic signals, ring road, and lane closing, to analyze lane changing and forward collision while considering vehicles and trucks as different objects. The scenarios also had two different lanes with different speed and road distance.

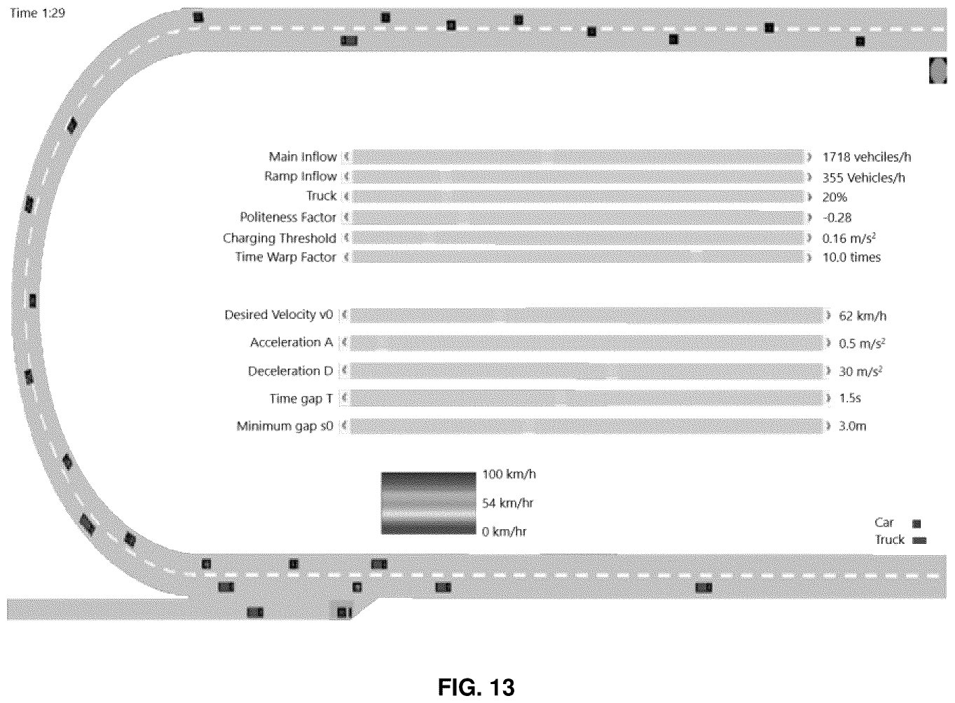

An average density meter increased or decreased the number of vehicles entering the scenario while a truck meter increased or decreased the number of trucks entering the scenario. Similarly, a desired velocity, acceleration, speed limit, and time gap of the vehicles and trucks was increased or decreased while adjusting the meters. The color of the vehicles (as seen in FIGS. 13-20) was determined by the speed of the vehicle, which is a feature included in the Java Swings interface.

The simulation for demonstrating autonomous driving in a multi-lane scenario was based on the following parameters. A number of vehicles and trucks entering the lanes could range from 0 to 4000 vehicles. A desired velocity could range from 1 to 199 Km/hr. A desired acceleration for this simulation could range from 0.3 to 2.9 m/s 2. The desired deceleration for this simulation could range from 0.5 to 4.9 m/s′. The desired time gap for this simulation could range from 0.3 to 2.9 sec. The desired distance between the vehicles could range from 0 to 7 m. The ratio of trucks to vehicles could range from 0 to 100%. A politeness factor was defined in a range from −1 to 2. The speed limit could range from 12-140 km.

### Example 1

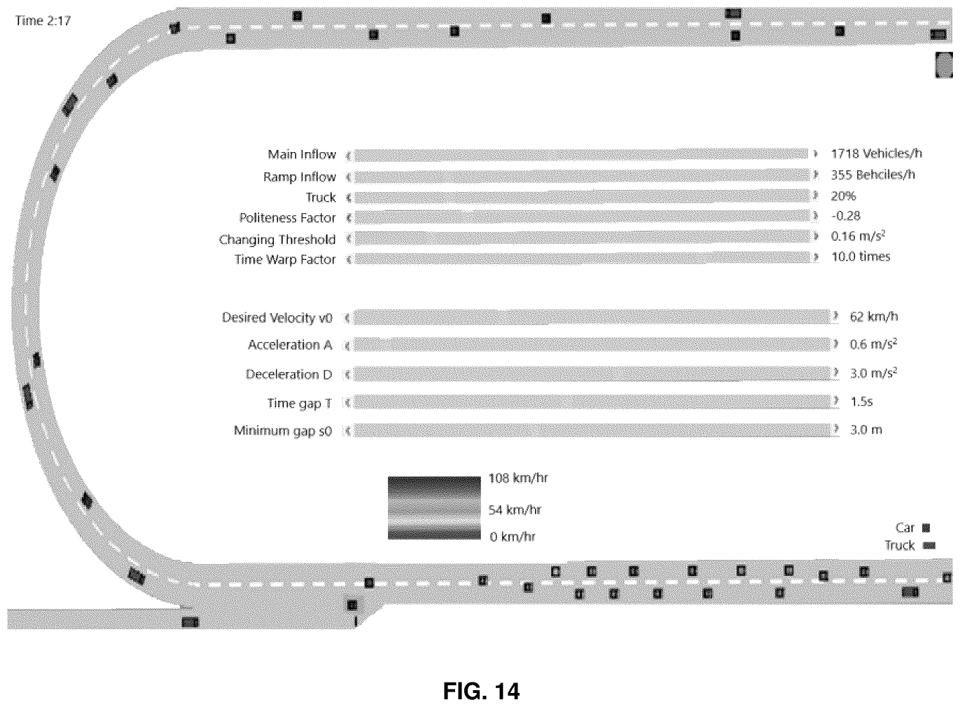

The first example run on the simulation was an on-ramp scenario. This scenario focuses on the vehicles merging into traffic from an entrance ramp. FIG. 13 depicts a subject vehicle entering the ramp and FIG. 14 depicts the subject vehicle merging into traffic. The subject vehicle prior to merging from the entrance ramp to the left lane ran through FIS-1 and FIS-2 in order to merge into traffic. The subject vehicle performed the following steps in order to make this merge. First, the subject vehicle determined the distance and the relative distance to adjust the speed of the vehicle. Second, the subject vehicle provided an input of a left lane to apply FIS-2 to determine if the vehicle should merge into the left lane. Third, the subject vehicle merged into the left lane after FIS-2 determined that it was appropriate to merge.

### Example 2

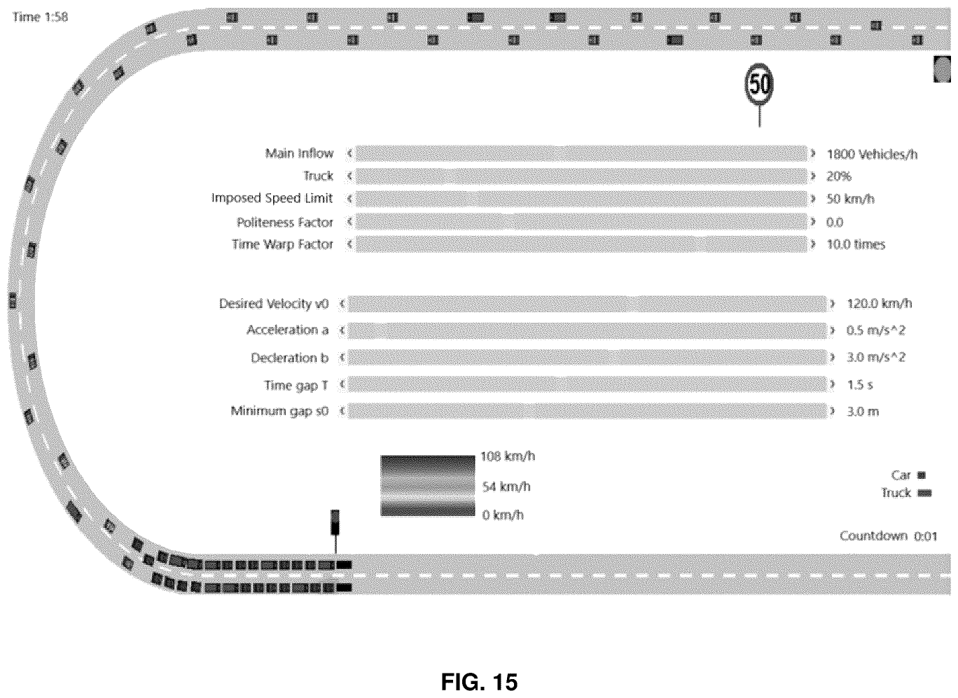

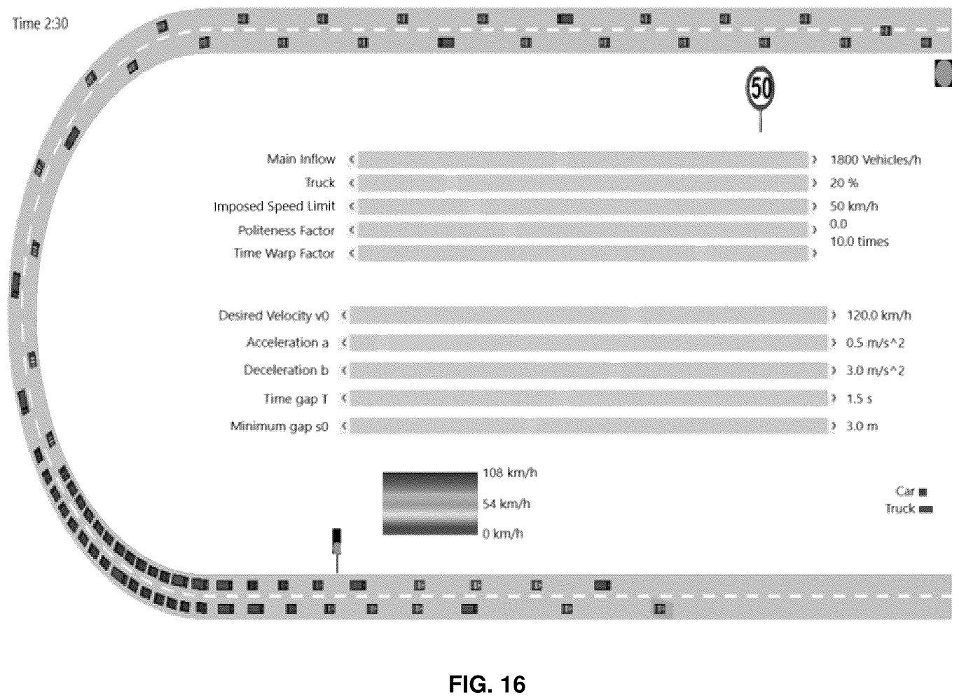

The second example run on the simulation was a traffic light scenario. This scenario shows neighboring vehicles and the subject vehicle coming to a stop at a red light and moving forward at a green light. FIG. 15 shows the vehicle stopping at the red light while FIG. 16 shows the same vehicle moving forward once the light turns green. In the traffic light scenario, the subject vehicle detects the distance from the red light and the relative distance of the red light to determine how to effectively stop the vehicle prior to the red light. The subject vehicle performed the following steps in order to stop at the red light. First, the subject vehicle determined the distance between the subject vehicle and the red light and its relative distance. Second, the second vehicle used the values gathered in FIS-1 to determine which action should happen with the subject vehicle. Third, the subject vehicle applied the break to stop the vehicle. Fourth, when the red light changed to the green light, the vehicle determined the distance of any object in front of the vehicle if it existed. If there was a determination that there was an object in front of the subject vehicle, the relative distance was determined. Fifth, the subject vehicle accelerated accordingly.

### Example 3

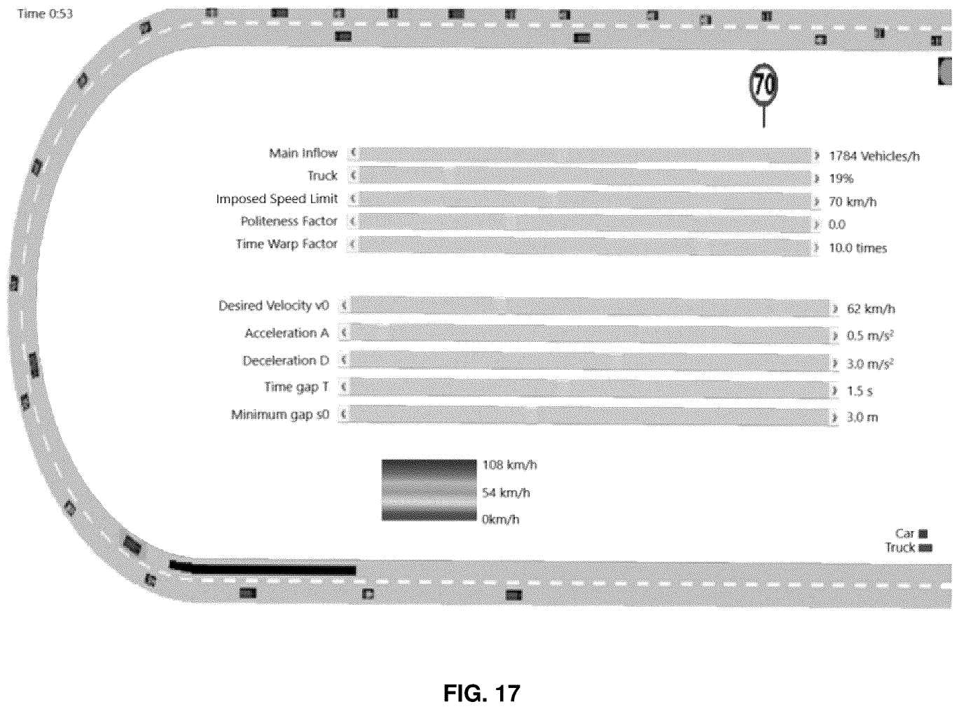

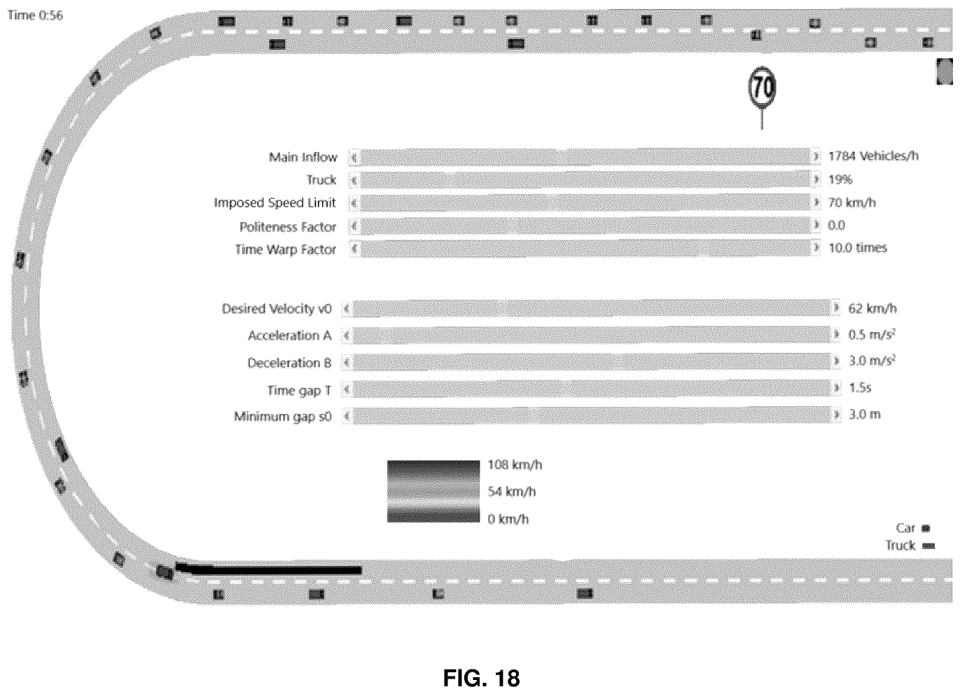

The third example run on the simulation was a lane closing scenario. This scenario shows what a subject vehicle does when there is an obstruction in one lane. The subject vehicle tries to change lanes in order to avoid the obstacle. FIG. 17 shows the subject vehicle slowing down while nearing the obstacle while FIG. 18 shows the subject vehicle changing lanes to avoid the obstacle. In the lane closing scenario, the subject vehicle detects a distance from the subject vehicle to the obstacle to determine which action the subject vehicle should take. The subject vehicle performed the following steps in order to merge and avoid the obstruction. First, the subject vehicle determined the distance of the subject vehicle. Second, the subject vehicle determined the relative distance. Third, the subject vehicle used FIS-2 in order to determine which action the vehicle should take. In the lane closing scenario it was determined that the vehicle needed to slow down and then merge into the right lane.

### Example 4

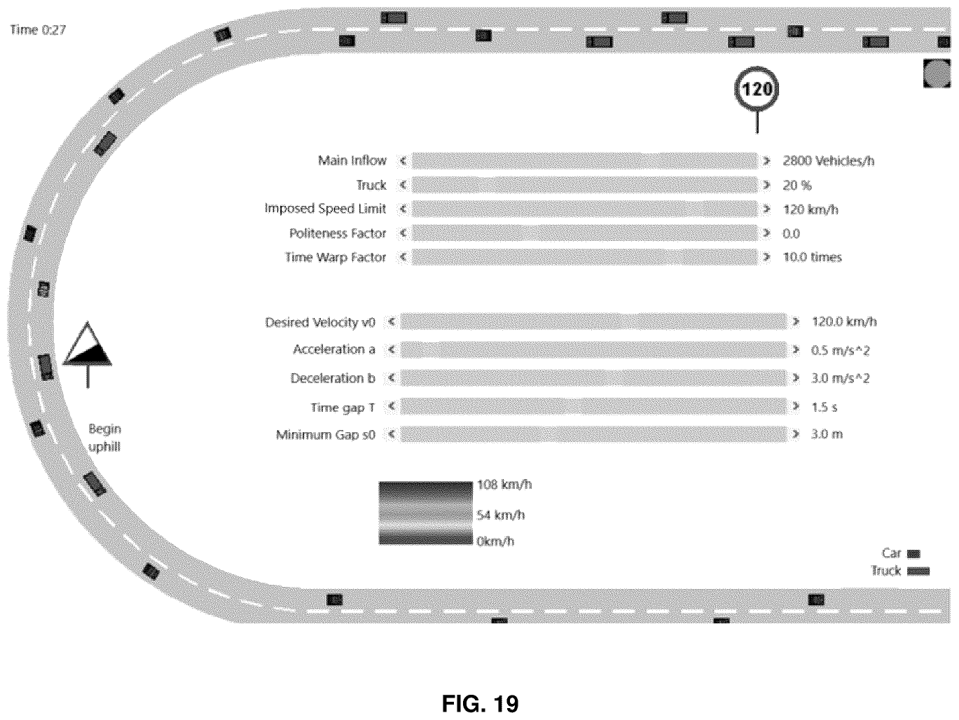

The fourth example run on the simulation was an uphill scenario. This scenario shows the vehicle controlling its speed while trying to go uphill. When climbing a steep incline, it is important to have control of the vehicle and not to overcompensate the engine. This scenario shows the subject vehicle climbing a steep incline and merging into a straight road in FIG. 19. FIS-1 was applied in the uphill scenario to determine which actions the subject vehicle should take to avoid overcompensating the engine. The steps taken were that the distance and relative distance were measured, and then in order to determine if the subject vehicle should speed up, these values of distance and relative distance were considered to calculate how much speed adjustment was appropriate to not overcompensate the engine.

### Example 5

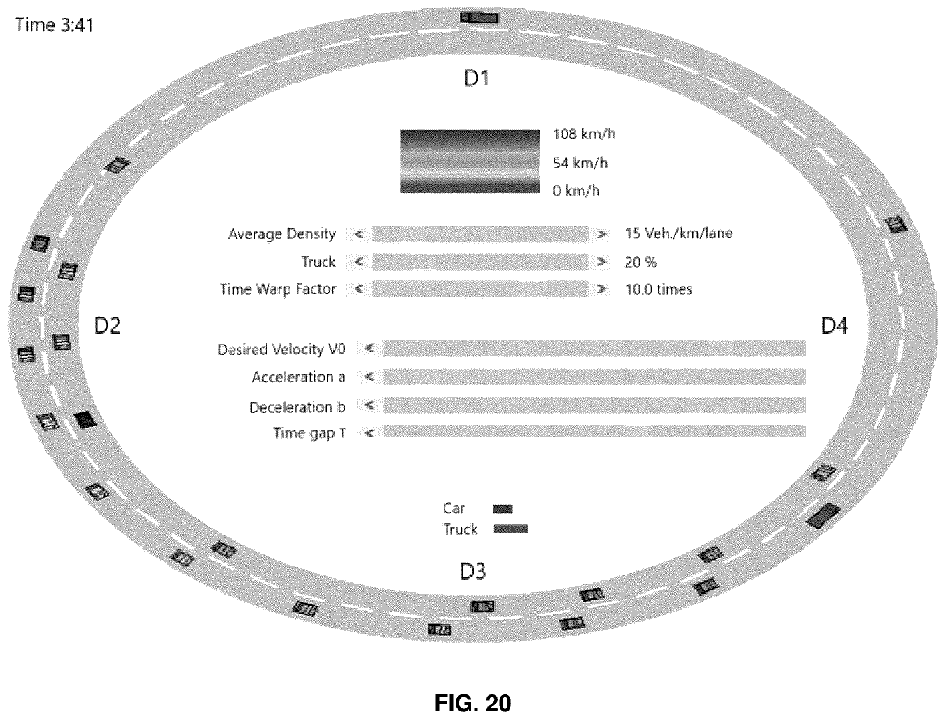

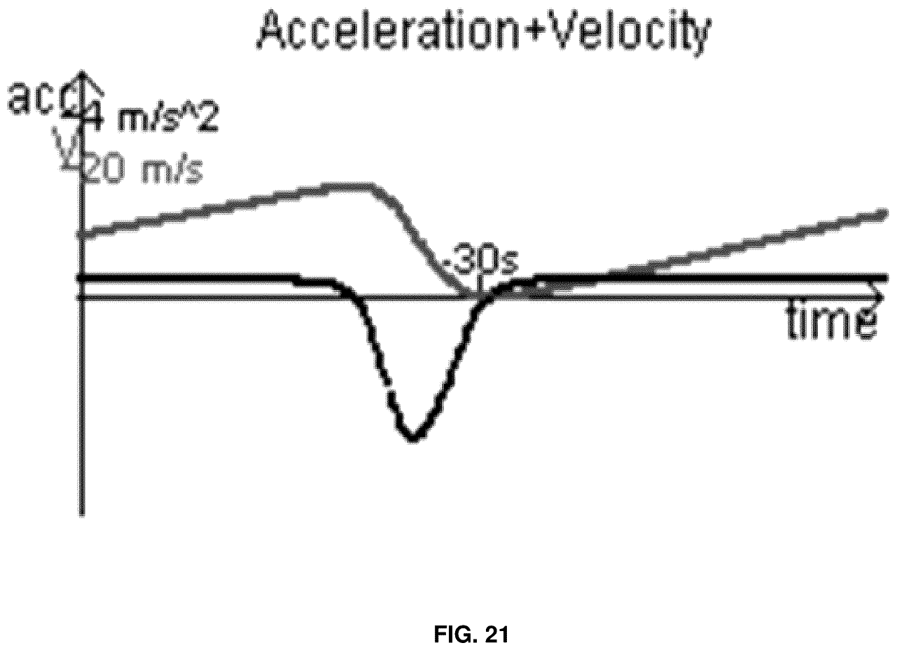

The fifth example run on the simulation was a circular road scenario. This scenario shows the subject vehicle going in a circular path. While going in a circular path, it is important to maintain speed during the continuous turns. This scenario shows the subject vehicle maintaining its speed while going in a circular path as can be seen in FIG. 20. FIG. 21 represents the acceleration of a blue vehicle compared to the relative velocity. The subject vehicle applied the logic of FIS-1 in order to determine speed control to properly maintain the speed of the subject vehicle.

### Example 6

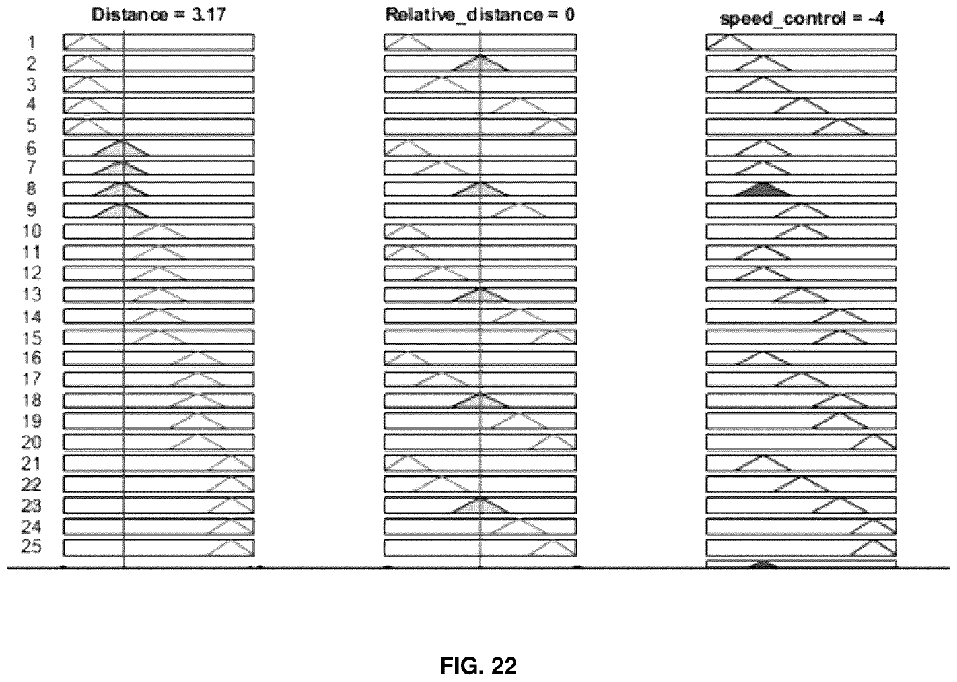

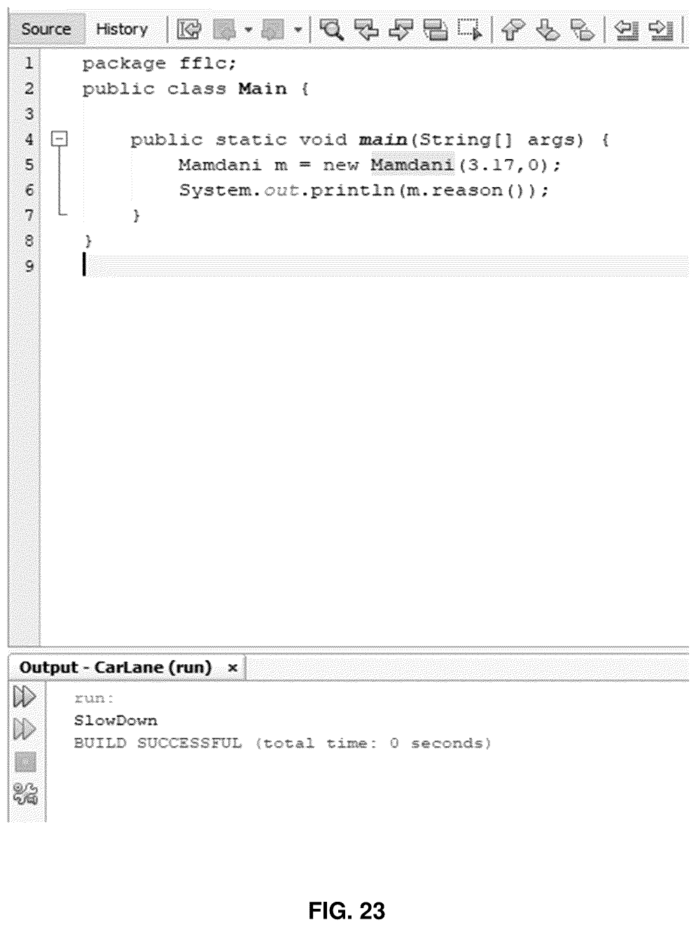

In FIS-1, the speed control FIS, the inputs of distance and relative distance were taken to give the output of speed control. FIG. 22 shows an example rule view in MATLAB, where the distance is given as 3.17 and the relative distance is given as 0. The rule view gives the output of −4 in speed control, which is slow down [−7, −4, −1] as can be seen in FIG. 4, when compared to the output membership values of FIS-1. These values when inserted into the Java software also give the same output of slow down as shown in FIG. 23.

### Example 7

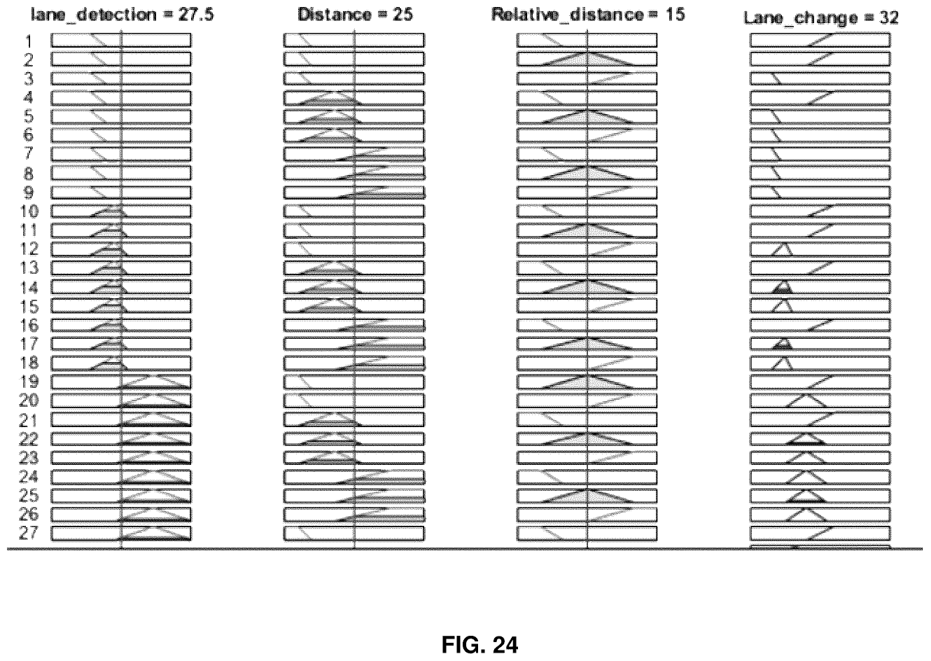

The rule view window of FIS-2 is shown in FIG. 24, when the given inputs are as follows: lane detection: 27.5; distance: 25; and relative distance: 15. These outputs produced an output of left lane, which indicates that the subject vehicle should change to the left lane.

Certain embodiments of the systems and methods disclosed herein are defined in the above examples. It should be understood that these examples, while indicating particular embodiments of the invention, are given by way of illustration only. From the above discussion and these examples, one skilled in the art can ascertain the essential characteristics of this disclosure, and without departing from the spirit and scope thereof, can make various changes and modifications to adapt the systems and methods described herein to various usages and conditions. Various changes may be made, and equivalents may be substituted for elements thereof without departing from the essential scope of the disclosure. In addition, many modifications may be made to adapt a particular situation or material to the teachings of the disclosure without departing from the essential scope thereof.

What is claimed is:

1. An advanced driving assistance system comprising a vehicle having a fuzzy inference system and a sensor, wherein:
the sensor is configured to obtain a first input comprising a distance and a second input comprising a relative distance;
the fuzzy inference system comprises a speed control logic set of fuzzy logic rules, the fuzzy inference system being configured to receive the first input and the second input from the sensor and generate an output relating to speed control;
the vehicle is configured to receive the output generated from the fuzzy inference system;
the distance is a measurement between the vehicle and an object in front of the vehicle;
the relative distance is a measurement of a rate of change of the distance; and
the output is a value of acceleration or a value of breaking.

2. The advanced driving assistance system of claim 1, wherein the fuzzy inference system is a Mamdani fuzzy inference system.

3. The advanced driving assistance system of claim 1, wherein the fuzzy inference system is a Sugeno fuzzy inference system.

4. The advanced driving assistance system of claim 1, wherein each of the first input, the second input, and the output comprises five membership functions that are triangular in nature.

5. The advanced driving assistance system of claim 4, wherein:
the five membership functions of the first input comprise variables of very small, small, perfect, large, and very large;
the five membership functions of the second input comprise variables of shrinking fast, shrinking, stable, growing, and growing fast; and
the five membership functions of the output comprise variables of break hard, slow down, no action, speed up, and floor it.

6. The advanced driving assistance system of claim 5, wherein the speed control logic set includes 25 fuzzy logic rules, wherein:
a first rule makes a determination based on the distance being very small and the relative distance shrinking fast that the vehicle should slow down quickly;
a second rule makes a determination based on the distance being very small and the relative distance being stable that the vehicle should slow down;
a third rule makes a determination based on the distance being very small and the relative distance being stable that the vehicle should slow down;
a fourth rule makes a determination based on the distance being very small and the relative distance growing that the vehicle should make no change to speed;
a fifth rule makes a determination based on the distance being very small and the relative distance growing fast that the vehicle should accelerate;
a sixth rule makes a determination based on the distance being small and the relative distance growing fast that the vehicle should slow down;
a seventh rule makes a determination based on the distance being small and the relative distance shrinking that the vehicle should slow down;
an eighth rule makes a determination based on the distance being small and the relative distance being stable that the vehicle should slow down;
a ninth rule makes a determination based on the distance being small and the relative distance growing that the vehicle should make no change in speed;
a tenth rule makes a determination based on the distance being small and the relative distance growing fast that the vehicle should accelerate;
an eleventh rule makes a determination based on the distance being perfect and the relative distance shrinking fast that the vehicle should slow down;
a twelfth rule makes a determination based on the distance being perfect and the relative distance shrinking that the vehicle should slow down;
a thirteenth rule makes a determination based on the distance being perfect and relative distance being stable that the vehicle should make no change in speed;
a fourteenth rule makes a determination based on the distance being perfect and the relative distance growing that the vehicle should accelerate;
a fifteenth rule makes a determination based on the distance being perfect and the relative distance growing fast that the vehicle should accelerate;
a sixteenth rule makes a determination based on the distance being large and the relative distance shrinking fast that the vehicle should slow down;
a seventeenth rule makes a determination based on the distance being large and the relative distance shrinking that the vehicle should make no change in speed;
an eighteenth rule makes a determination based on the distance being large and the relative distance being stable that the vehicle should accelerate;
a nineteenth rule makes a determination based on the distance being large and the relative distance growing that the vehicle should accelerate;
a twentieth rule makes a determination based on the distance being large and the relative distance growing fast that the vehicle should accelerate quickly;
a twenty-first rule makes a determination based on the distance being very large and the relative distance shrinking fast that the vehicle should slow down;
a twenty-second rule makes a determination based on the distance being very large and the relative distance shrinking that the vehicle should make no change in speed;
a twenty-third rule makes a determination based on the distance being very large and the relative distance being stable that the vehicle should accelerate;
a twenty-fourth rule makes a determination based on the distance being very large and the relative distance growing that the vehicle should accelerate quickly; and
a twenty-fifth rule makes a determination based on the distance being very large and the relative distance growing fast that the vehicle should accelerate quickly.

7. A method of controlling speed in a vehicle using an advanced driving assistance system, the method comprising:
obtaining a first input with a sensor, the first input comprising a distance between the vehicle and an object in front of the vehicle;
obtaining a second input with the sensor, the second input comprising a relative distance, wherein the relative distance is a measurement of a rate of change of the distance; and
implementing a fuzzy inference system by applying a set of fuzzy logic rules to the obtained first input and second input so as to generate an output comprising a recommendation to adjust or maintain a speed of the vehicle.

8. The method of claim 7, wherein the fuzzy inference system is a Mamdani fuzzy inference system.

9. The method of claim 7, wherein the fuzzy inference system is a Sugeno fuzzy logic system.

10. The method of claim 7, wherein each of the first input, the second input, and the output comprises five membership functions that are triangular in nature.

11. The method of claim 10, wherein:
the five membership functions of the first input comprise variables of very small, small, perfect, large, and very large;
the five membership functions of the second input comprise variables of shrinking fast, shrinking, stable, growing, and growing fast; and
the five membership functions of the output comprise variables of break hard, slow down, no action, speed up, and floor it.

12. The method of claim 11, wherein the set of fuzzy logic rules includes 25 fuzzy logic rules, wherein:
a first rule makes a determination based on the distance being very small and the relative distance shrinking fast that the vehicle should slow down quickly;
a second rule makes a determination based on the distance being very small and the relative distance being stable that the vehicle should slow down;
a third rule makes a determination based on the distance being very small and the relative distance being stable that the vehicle should slow down;
a fourth rule makes a determination based on the distance being very small and the relative distance growing that the vehicle should make no change to speed;
a fifth rule makes a determination based on the distance being very small and the relative distance growing fast that the vehicle should accelerate;
a sixth rule makes a determination based on the distance being small and the relative distance growing fast that the vehicle should slow down;
a seventh rule makes a determination based on the distance being small and the relative distance shrinking that the vehicle should slow down;
an eighth rule makes a determination based on the distance being small and the relative distance being stable that the vehicle should slow down;
a ninth rule makes a determination based on the distance being small and the relative distance growing that the vehicle should make no change in speed;
a tenth rule makes a determination based on the distance being small and the relative distance growing fast that the vehicle should accelerate;
an eleventh rule makes a determination based on the distance being perfect and the relative distance shrinking fast that the vehicle should slow down;
a twelfth rule makes a determination based on the distance being perfect and the relative distance shrinking that the vehicle should slow down;
a thirteenth rule makes a determination based on the distance being perfect and relative distance being stable that the vehicle should make no change in speed;
a fourteenth rule makes a determination based on the distance being perfect and the relative distance growing that the vehicle should accelerate;
a fifteenth rule makes a determination based on the distance being perfect and the relative distance growing fast that the vehicle should accelerate;
a sixteenth rule makes a determination based on the distance being large and the relative distance shrinking fast that the vehicle should slow down;
a seventeenth rule makes a determination based on the distance being large and the relative distance shrinking that the vehicle should make no change in speed;
an eighteenth rule makes a determination based on the distance being large and the relative distance being stable that the vehicle should accelerate;
a nineteenth rule makes a determination based on the distance being large and the relative distance growing that the vehicle should accelerate;
a twentieth rule makes a determination based on the distance being large and the relative distance growing fast that the vehicle should accelerate quickly;
a twenty-first rule makes a determination based on the distance being very large and the relative distance shrinking fast that the vehicle should slow down;
a twenty-second rule makes a determination based on the distance being very large and the relative distance shrinking that the vehicle should make no change in speed;
a twenty-third rule makes a determination based on the distance being very large and the relative distance being stable that the vehicle should accelerate;
a twenty-fourth rule makes a determination based on the distance being very large and the relative distance growing that the vehicle should accelerate quickly; and
a twenty-fifth rule makes a determination based on the distance being very large and the relative distance growing fast that the vehicle should accelerate quickly.

13. An advanced driving assistance system comprising a vehicle having a fuzzy inference system and a sensor, the sensor being configured to obtain a first input comprising a lane detection, a second input comprising a distance, and a third input comprising a relative distance, wherein:
the fuzzy inference system is a lane change logic set of fuzzy logic rules, the fuzzy inference system being configured to receive the first input, the second input, and the third input from the sensor and generate an output comprising a lane change recommendation based on the first input, the second input, and the third input;
the lane detection is the detection of a parallel lane into which the vehicle may move through a change of lanes;
the distance is a measurement between the vehicle and an object in front of the vehicle; and
the relative distance is a measurement of a rate of change of a second distance between the vehicle and an object detected in the parallel lane.

14. The advanced driving assistance system of claim 13, wherein the fuzzy inference system is a Mamdani fuzzy inference system.

15. The advanced driving assistance system of claim 13, wherein the fuzzy inference system is a Sugeno fuzzy inference system.

16. The advanced driving assistance system of claim 13, wherein each of the first input, the second input, and the third input comprises three membership functions that are triangular or trapezoidal in nature, and wherein the output comprises four membership functions.

17. The advanced driving assistance system of claim 16, wherein:
the three membership functions of the first input comprise variables of right lane, middle lane, and left lane;
the three membership functions of the second input comprise variables of small, perfect, and large;
the three membership functions of the third input comprise variables of shrinking, stable, and growing; and
the four membership functions of the output comprise variables of right lane, middle lane, left lane, and no action.

18. The advanced driving assistance system of claim 17, wherein the lane change logic set of fuzzy logic rules includes 27 fuzzy logic rules, wherein:
a first rule makes a determination based on the lane detection being right lane, the distance being small, and the relative distance shrinking that the vehicle should stay in its current
a second rule makes a determination based on the lane detection being right lane, the distance being small, and the relative distance being stable that the vehicle should stay in its current lane;
a third rule makes a determination based on the lane detection being right lane, the distance being small, and the relative distance growing that the vehicle should stay in its current lane;
a fourth rule makes a determination based on the lane detection being right lane, the distance being perfect, and the relative distance shrinking that the vehicle should stay in its current lane;
a fifth rule makes a determination based on the lane detection being right lane, the distance being perfect, and the relative distance being stable that the vehicle should change to the right lane;
a sixth rule makes a determination based on the lane detection being right lane, the distance being perfect, and the relative distance growing that the vehicle should change to the right lane;
a seventh rule makes a determination based on the lane detection being right lane, the distance being large, and the relative distance shrinking that the vehicle should change to the right lane;
an eighth rule makes a determination based on the lane detection being a right lane, the distance being large, and the relative distance being stable that the vehicle should change to the right lane;
a ninth rule makes a determination based on the lane detection being right lane, the distance being large, and the relative distance growing that the vehicle should change to the right lane;
a tenth rule makes a determination based on the lane detection being middle lane, the distance being small, and the relative distance shrinking that the vehicle should stay in its current lane;
an eleventh rule makes a determination based on the lane detection being middle lane, the distance being small, and the relative distance being stable that the vehicle should stay in its current lane;
a twelfth rule makes a determination based on the lane detection being middle lane, the distance being small, and the relative distance growing that the vehicle should change to the middle lane;
a thirteenth rule makes a determination based on the lane detection being middle lane, the distance being perfect, and the relative distance shrinking that the vehicle should stay in its current lane;
a fourteenth rule makes a determination based on the lane detection being middle lane, the distance being perfect, and the relative distance being stable that the vehicle should change to the middle lane;
a fifteenth rule makes a determination based on the lane detection being middle lane, the distance being perfect, and the relative distance growing that the vehicle should change to the middle lane;
a sixteenth rule makes a determination based on the lane detection being middle lane, the distance being large, and the relative distance shrinking that the vehicle should change to the middle lane;
a seventeenth rule makes a determination based on the lane detection being middle lane, the distance being large, and the relative distance being stable that the vehicle should change to the middle
an eighteenth rule makes a determination based on the lane detection being middle lane, the distance being large, and the relative distance growing that the vehicle should change to the middle lane;
a nineteenth rule makes a determination based on the lane detection being left lane, the distance being small, and the relative distance shrinking that the vehicle should stay in its current lane;
a twentieth rule makes a determination based on the lane detection being left land, the distance being small, and the relative distance being stable that the vehicle should stay in its current lane;
a twenty-first rule makes a determination based on the lane detection being left lane, the distance being small, and the relative distance growing that the vehicle should change to the left lane;
a twenty-second rule makes a determination based on the lane detection being left lane, the distance being perfect, and the relative distance shrinking that the vehicle should stay in its current lane;
a twenty-third rule makes a determination based on the lane detection being left lane, the distance being perfect, and the relative distance being stable that the vehicle should change to the left lane;
a twenty-fourth rule makes a determination based on the lane detection being left lane, the distance being perfect, and the relative distance growing that the vehicle should change to the left lane;
a twenty-fifth rule makes a determination based on the lane detection being left lane, the distance being large, and the relative distance shrinking that the vehicle should change to the left lane;
a twenty-sixth rule makes a determination based on the lane detection being left lane, the distance being large, and the relative distance being stable that the vehicle should change to the left lane; and
a twenty-seventh rule makes a determination based on the lane detection being left lane, the distance being large, and the relative distance growing that the vehicle should change to the left lane.

19. A method of changing lanes in a vehicle using an advanced driving assistance system, the method comprising:
obtaining a first input with a sensor, the first input comprising a lane detection, wherein the lane detection is a detection of a parallel lane into which the vehicle may move in a change of lanes;
obtaining a second input with the sensor, the second input comprising a distance, wherein the distance is a measurement between the vehicle and an object in front of the vehicle;
obtaining a third input with the sensor, the third input comprising a relative distance, wherein the relative distance is a measurement of a rate of change of a distance between the vehicle and an object detected in the parallel lane;
implementing a fuzzy inference system to apply a set of fuzzy logic rules to the first input, the second input, and the third input so as to generate an output, wherein the output comprises a recommendation on whether the vehicle should change lanes into the parallel lane.

20. An advanced driving assistance system comprising a vehicle having a sensor in communication with a first fuzzy inference system and a second fuzzy inference system, wherein:
the sensor is configured to obtain a first input of the first fuzzy inference system comprising a first distance, a second input of the first fuzzy inference system comprising a first relative distance, a first input of the second fuzzy inference system comprising a lane detection, a second input of the second fuzzy inference system comprising the distance, and a third input of the second fuzzy inference system comprising a second relative distance;
the first fuzzy inference system comprises a speed control logic set of fuzzy logic rules, and is configured to receive the first input of the first fuzzy inference system and the second input of the first fuzzy inference system from the sensor, and generate a first output comprising a speed control recommendation;
the second fuzzy inference system comprises a lane change logic set of fuzzy logic rules, and is configured to receive the first input of the second fuzzy inference system, the second input of the second fuzzy inference system, and the third input of the second fuzzy inference system, and generate a second output comprising a lane change recommendation;
the distance is a measurement between the vehicle and an object in front of the vehicle;
the relative distance is a measurement of a rate of change of the distance;
the lane detection is a detection of a parallel lane into which the vehicle may move in a change of lanes; and
the second relative distance is a measurement of the rate of change of a second distance between the vehicle and an object detected in the parallel lane.
